(19) United States
(12) Patent Application Publication
(10) Pub. No.: US 2007/0011029 A1
(43) Pub. Date: Jan. 11, 2007

(54) Access to inpatient medical information for patient and proxies

(76) Inventors: Christine M. Benson, Madison, WI (US); Daniel J. Donoghue, Oregon, WI (US); Davin Sannes, Mount Horeb, WI (US); Matthew Sidney, Fitchburg, WI (US); Brian R. Stoll, Verona, WI (US)

Correspondence Address: QUARLES & BRADY LLP, 411 E. WISCONSIN AVENUE, SUITE 2040, MILWAUKEE, WI, 53202-4497, US

(21) Appl. No.: 11/176,991

(22) Filed: Jul. 8, 2005

(51) Int. Cl. G06F 19/00; G06F 17/30

(52) U.S. Cl. 705/3; 707/9

(57) ABSTRACT

A method and apparatus for making information associated with a patient at a medical facility available, the method comprising the steps of providing a processor, a database and at least a first interface device, the processor linked to each of the interface device and the database via a network and during an admit period that occurs between admission of a first patient to and discharge of the first patient from the facility, allowing at least one of the first patient and a proxy for the first patient to access at least a subset of admit period information associated with the first patient that reflects activities related to the first patient that occur during the admit period where the admit period information includes official facility generated information.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

When a person is admitted to a medical facility, in many cases concerned family and friends will want to obtain information about the patient's condition. For example, assume that a teenager named Edward Mifflin sustains several injuries in an automobile accident and is taken to Saint Mary's medical facility for treatment. Also assume that Edward Mifflin's mother and two siblings live in different parts of the United States. In this case, Edward's mother and siblings each may want to obtain as much information as possible and as quickly as possible regarding Edward's location, injuries sustained, current medical status, prognosis, etc. In addition, during Edward's stay at the facility, each of his mother and siblings may want routine updates regarding his status.

When a patient is admitted to a facility for several days or more, often the patient himself would like to access and analyze information generated by the facility during the admit period that is related to the patient. For instance, where medical images of the patient are generated, the patient may want to access and personally examine the images. As another instance, the patient may want to examine a physician's comments regarding specific test results or a diagnosis based on observed symptoms. As still one other instance, a patient may want to access a test/procedure schedule for a following day.

Currently, known ways for a patient's relatives and friends to obtain inpatient information in situations like the one described above include making a phone call to an employee at the admitting facility or calling some other person such as another relative of the patient to obtain any information second hand that the other person may have obtained from the admitting facility.

In many cases admitting facilities will not provide information regarding admitted patients without verification of (1) the identity of a person calling to obtain the information and (2) some special relationship (e.g., family member) to the patient. In many cases there is no way for an admitting facility to verify identity of a person calling to obtain information and therefore the option to call a facility to obtain information is useless.

Even where a facility has the ability to verify the identity of a patient's family members, friends, etc., many facilities have strict guidelines regarding who can provide information to the interested parties. For instance, in many cases, facilities have guidelines that prohibit all but physicians from releasing or discussing certain types of inpatient information to interested parties. Because many physicians have busy schedules, physicians typically are not available at many times to release accurate information to family members, friends, etc. and would prefer to communicate information to one or a small group of people related to a patient with the expectation that the communicated information would be forwarded to other interested parties. Where information has to be obtained second hand (i.e., through another relative), the information obtained is often incomplete, mis-communicated and/or at least in part inaccurate.

Similarly, known ways for patients to access patient information during admission to a facility include requesting the information from a physician, nurse, etc. Here, while physicians and nurses certainly are capable of responding to such requests, processing such requests is time consuming and hence burdensome. Knowing that such requests would likely be viewed as burdensome, even when patients would like to examine certain types of information, those patients often forego access.

Thus, there is a need for a system whereby admitted patients can access information generated by a medical facility during the period of patient admission and whereby patient family members, friends, etc., can also access at least some verified and first hand information regarding the status of a patient during admission. In at least some cases it would also be advantageous if the system could allow family members, friends, etc., to access information associated with an admitted patient including pre and post admission information such as medical history, etc.

### BRIEF DESCRIPTION OF THE SEVERAL VIEWS OF THE DRAWINGS

FIG. 1 is a schematic diagram illustrating an exemplary information system that may be used to implement at least some embodiments of the present invention;

FIG. 2 is a schematic diagram illustrating an exemplary patient access database that may be used by the system of FIG. 1;

FIG. 3 is a flow chart illustrating an abbreviated method for forming a patient admit period information account and facilitating patient access to that account during an admit period that may be performed by the server of FIG. 1;

FIG. 4 is a flow chart illustrating a submethod that may be substituted for a portion of the method of FIG. 3 for customizing ADPI accessibility by patients that may be performed by the server of FIG. 1;

FIG. 5 is a window view that may be provided by the server of FIG. 1 for customizing ADPI accessibility by a patient;

FIG. 6 is a flow chart illustrating a method of providing patient access to patient related information during admission to a medical facility;

FIG. 7 is a window view that may be provided by the server of FIG. 1 when performing a portion of the method illustrated in FIG. 6;

FIG. 8 is similar to FIG. 7, albeit illustrating a window view that may be provided by the server of FIG. 1 during a different portion of the method of FIG. 6;

FIG. 9 is a flow chart illustrating a method that may be performed by the server of FIG. 1 that enables a physician to render specific information accessible to an admitted patient;

FIG. 10 is a window view that may be provided by the server of FIG. 1 to aid a physician in identifying specific information that should be rendered accessible to an admitted patient;

FIG. 11 is a schematic diagram of a proxy access database that may be employed by the server of FIG. 1 to perform at least some inventive methods;

FIG. 12 is a flow chart illustrating a method performed by the server of FIG. 1 in at least some inventive embodiments for specifying proxy access to ADPI for specific patient;

FIG. 13 is a window view that may be provided by the server of FIG. 1 during at least a portion of the method of FIG. 12;

FIG. 14 is similar to FIG. 13, albeit illustrating a window view that may be provided by the server of FIG. 1 during a different portion of the method of FIG. 12;

FIG. 15 is a window view that may be provided during yet another portion of the method illustrated in FIG. 12;

FIG. 16 is a window view that may be provided during one additional portion of the method illustrated in FIG. 12;

FIG. 17 is a window view that may be provided during a portion of the method illustrated in FIG. 12 for obtaining proxy names and e-mail addresses;

FIG. 18 is an exemplary e-mail notice that may be provided to a proxy when a patient is admitted to a medical facility;

FIG. 19 is a window view that may be provided by the server of FIG. 1 when a proxy accesses ADPI corresponding to an admitted patient;

FIG. 20 is a flow chart illustrating a submethod that may be substituted for a portion of the method of FIG. 12 in at least some embodiments where a patient can grant or modify proxy access;

FIG. 21 is a flow chart illustrating a method of providing notice of ADPI updates to proxies;

FIG. 22 is an exemplary e-mail notice that may be provided to a proxy when an ADPI that the proxy has authority to access has been updated or modified;

FIG. 23 is a screen shot that may be used with another exemplary inventive system;

FIG. 24 is a screen shot that may be used according to one aspect of at least some embodiments of the present invention;

FIG. 25 is a screen shot that may be used according to another aspect of at least some inventive embodiments; and

FIG. 26 is flow chart illustrating an exemplary method whereby a potential proxy requests proxy access from a patient.

### DETAILED DESCRIPTION OF THE INVENTION

One or more specific embodiments of the present invention will be described below. It should be appreciated that in the development of any such actual implementation, as in any engineering or design project, numerous implementation-specific decisions must be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication and manufacture for those of ordinary skill having the benefit of this disclosure.

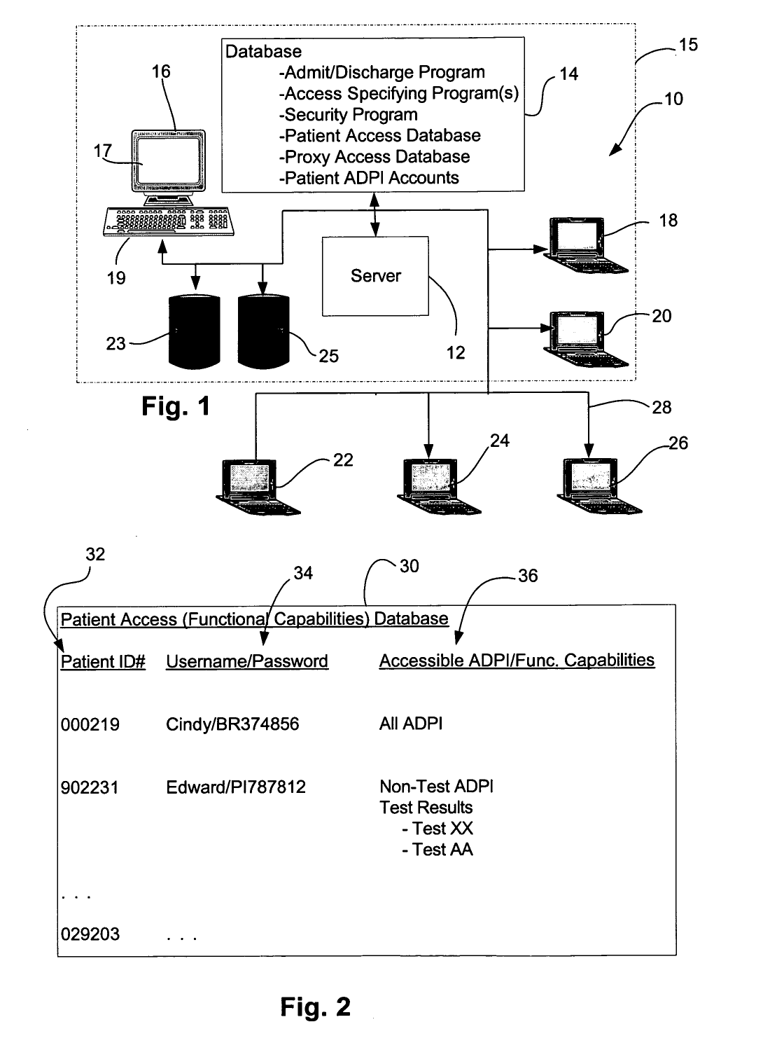

Referring now to the drawing wherein like reference numerals correspond to similar elements throughout the several views and, more specifically, referring to FIG. 1, the present invention will be described in the context of an exemplary hospital information system 10 that is supported by and used by a medical facility and people associated with the medical facility to manage and store patient and facility information as well as to facilitate access to that information by facility employees that have a need to access the information (e.g., physician, nurses, administrators, etc.), by patients and by other parties that have been authorized to access at least subsets of patient related information.

Hereinafter, while system 10 is described in the context of an exemplary Saint Mary's Hospital and in the context of a small number of exemplary facility patients, record types and records, it should be appreciated that system 10 is meant to be used in far more complex systems for managing huge numbers of record types and records for hundreds and even thousands of facility patients. In addition, in the interest of simplifying this explanation, unless indicated otherwise, the invention will be described in the context of an exemplary patient named Edward Mifflin and his mother Jeanne Mifflin who, in at least some embodiments, is authorized to remotely and/or locally access information related to Edward Mifflin during a period while her son is admitted to Saint Mary's medical facility. In addition, hereinafter, unless indicated otherwise, an authorized patient representative such as Jeanne Mifflin will be referred as a “proxy” and, when a proxy accesses a patient's information, the accessing activity will be referred to as “proxy access”. In addition, unless indicated otherwise, the phrase “admit period” will be used to refer to the period during which a patient is admitted to the St. Mary's medical facility (i.e., the time between the patient's admission and discharge from the medical facility). Furthermore, while at least some embodiments will be used exclusively to access records and information generated while a patient is admitted to a medical facility, in other cases it is contemplated that a system may be useable to access information corresponding to a longer period of time including pre and post admission period information such as medical histories, post-admission updates, etc., or to access information that is episodically related (i.e., information related to treatment of a particular condition). For instance, a patient may have a congestive heart failure episode that includes a heart attach, an inpatient admission, a discharge, labs, meds, and notes after admission as well as a related admission for surgery to fix a diagnosed problem. Here, in at least some cases, a patient and/or one or more proxies may be given access to all of the episodically related information as the information is generated.

Referring to FIG. 1, system 10 includes a server 12, a database 14, an admit/discharge interface or workstation 16, a plurality of employee interface devices, two of which are identified by numerals 18 and 20, a plurality of patient interface devices, two of which are labeled 23 and 25, a plurality of remote or proxy interface devices 22, 24, 26, etc, and an expansive information network 28 (e.g., the internet, a local or wide area network, etc). Here, the phrase “employee device” is used to refer generally to a an interface device linked to network 28 to enable facility employees to access patient data and software applications required to perform various facility and patient related tasks. In at least some cases at least a subset of devices 18, 20, etc., may be located outside the Saint Mary's facility at a related facility, at a physician's home, etc. In FIG. 1, numeral 15 indicates the bounds of the exemplary Saint Mary's facility. The phrase “patient device” is used to refer to interface devices primarily used by admitted patients and the phrase “proxy device” is used to refer to interface devices used by a representative for an admitted patient to access information about the patient. In at least some cases one or more proxy devices may also be used by an extended group of interested persons that, while not in a position to represent and make decisions for a patient, are nevertheless interested in activities/conditions associated with the patient. For instance, an aunt of a patient may be interested in checking up on the patient's status even though the aunt has nothing to do with making decisions related to treatment, etc. Hereinafter, unless indicated otherwise, a person in an extended group of interested persons will be referred to as an “observer”.

Because patient devices are used by patients during admit periods, those devices are necessarily within facility 15 or at least on premises of other facilities associated with facility 15 (here related facilities and computing systems are generally referred to as an enterprise). Proxy devices 22, 24, 26, etc., on the other hand, may be either remote (i.e., outside facility 15) or within facility 15 or related facilities or, in the case of portable proxy devices, may be remote at times and within facility 15 at other times.

Referring still to FIG. 1, sever 12 is linked by information network 28 for two-way communication with workstation 16, database 14 and interface devices 18, 20, 22, 23, 24, 25 and 26. Server 12 performs several different functions including patient admission to and discharge from facility 15 and functions related to patient information control. To facilitate admission/discharge of facility patients, an admit/discharge program is stored in database 14. Similarly, to facilitate control of patient related information while a patient is admitted to facility 15, one or more access specifying programs and a security program are each stored on database 14 and are accessible to server 12. In addition to the programs referenced above, database 14 also stores a patient access database, a proxy access database and patient admit period information (ADPI) accounts. These programs and databases are described in greater detail below.

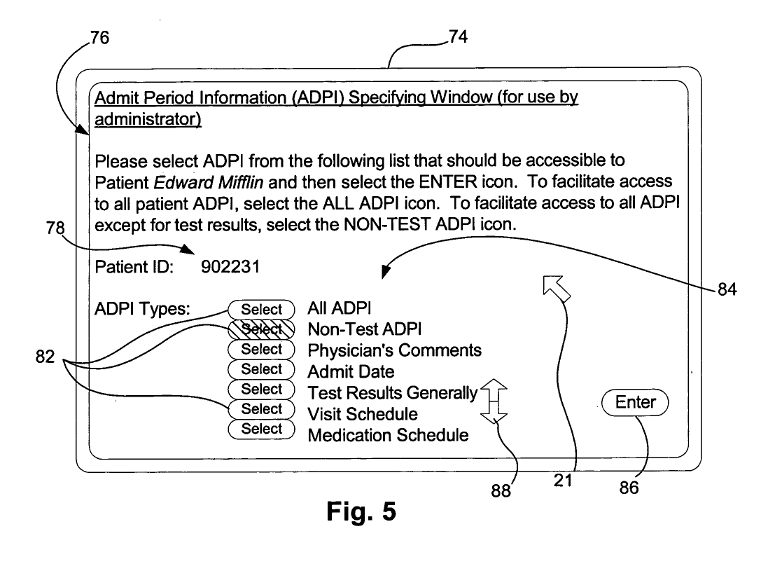

Referring again to FIG. 1, workstation 16 is a computer workstation which, in at least some applications, is used to admit/discharge patients from facility 15 as well as to specify patient and/or proxy access rules governing patient and proxy access to patient ADPI records stored on database 14. To this end, workstation 16 may be located adjacent a main facility entrance such that, as a patient enters the facility, a facility intake administrator using workstation 16 is positioned to greet the patient upon entry, obtain preliminary information from the patient regarding identity, symptoms, etc., and to enter the preliminary information via workstation 16 to create an initial patient record or update an existing record. Workstation 16 includes a display screen 17 and one or more input devices 19. In FIG. 1, input device 19 includes a keyboard but other input devices are contemplated such as a mouse, a trackball, etc. Referring also to FIG. 5, a mouse controlled pointing icon 21 is illustrated that is useable to point to on display screen icons as well known in the art.

Referring still to FIG. 1, patient interface devices 23 and 25 are, in at least some applications, located throughout Saint Mary's facility 15 at patient accessible locations thereby enabling admitted patients to access at least a subset of the information stored on database 14 as well to access and operate some application programs stored on database 14. For example, in at least some embodiments, it is contemplated that patient interface devices 23, 25, etc., will be located in patient rooms so that admitted patients can access information and programs on database 14 from the comfort of their rooms. For instance, a patient may want to access a next day medical test schedule. Other types of patient specific information a patient may want to access while admitted include but are not limited to medical test results, the patient's condition during the admit period, a patient's past schedule during the admit period, past, present and future medication consumption for the patient, information corresponding to patient interaction with physicians, information previously posted by the patient (e.g., queries to physicians or information indicating the patient's own perception of condition), physician posted information, proxy posted information where such information collection is supported, insurance information, medical images associated with the patient, administrative procedural documents, medical procedural documents, food menu options at the facility, current patient diagnosis, past patient diagnosis, historical information related to level of consciousness of the patient, patient characteristics, visitation schedule, patient diet, appointment scheduling software, visitation scheduling software, a bulletin board for communicating with family and friends, etc.

As indicated above, proxy interface devices 22, 24 and 25 are devices used by patient proxies or observers to access information associated with patients that are currently admitted to facility 15. For example, consistent with the assumptions above where Jeanne Mifflin is a proxy for her son Edward Mifflin during a one week admit period, Jeanne may want to periodically access information related to Edward's current condition, visitation schedules, level of consciousness, etc. Here, in at least some embodiments of the present invention, Jeanne is able to use a proxy interface device 22 to access the desired information.

Referring still to FIG. 1, while devices 18, 20, 22, etc., are illustrated as being lap top computers and patient devices 23, 25, etc. are illustrated as being palm type computers, it should be appreciated that any of the interface devices in FIG. 1 may take any of several different forms including but not limited to personal computers, work stations, digital telephones, personal digital assistants, interactive television sets and systems such as the Web TV system, etc. Here, it should suffice to say that the interface devices used with the present invention should include at least some way of communicating information to a device user (e.g., a display screen) as well as some way of receiving information from the device user such as via either a mechanical or electronic keyboard, voice input, etc.

Referring again to FIG. 1, during a patient admission process when a new patient is admitted, in at least some embodiments, server 12 automatically generates a patient ADPI account for the specific patient where, as the label implies, information associated with or corresponding to the patient that is generated during the admit period is stored. In addition, according to at least some embodiments of the present invention, during the admission process, server 12 generates patient access information that is required for the patient to access ADPI account information during the patient's admit period. In some embodiments it is contemplated that during an admission period a patient will be able to access virtually all of the ADPI account information related to the patient. In other embodiments it is contemplated that each admitted patient will only be able to access a precanned subset of ADPI account information for the specific patient. For example, while it may be advantageous to allow facility patients to view medical images, it may be imprudent to allow patients to examine a physician's conclusions regarding specific medical images.

In still other embodiments it is contemplated that ADPI account information may be affirmatively released by facility physicians at different times or for periods shorter than the remainder of an admit period for access by patients. For example, in the case of a medical image and a physician's conclusions related thereto, a patient may initially be restricted from accessing the image and the physician's conclusions until after a physician confers with the patient. After a physician-patient conference, the images and a written conclusion may be released for the patient to independently access. As another example, where a patient is subjected to a series of similar tests over the course of an admit period, it may be desirable to only allow patient access to the most recent test results to avoid inundating the patient with information and potential confusion. In this case, as new test results are stored as ADPI, access to old test results would be blocked and hence access would be restricted prior to discharge.

In still other embodiments it is contemplated that patient access rights to ADPI account information may be tailored on a patient-by-patient basis or as a function of specific patient characteristics/circumstances (i.e., as a function of case type). For example, in a case where a first patient is admitted to facility 15 after a car accident in which several bones have been broken, that patient may be granted greater access to ADPI account information than a second admitted patient that has a devastating type of cancer where a physician may want to release ADPI account information in a relatively more sensitive manner (e.g., personally). Here, upon admission, when a case type or the like is identified by the facility intake administrator, server 12 may automatically tailor specific default access rules as a function of case type.

Referring to FIG. 2, an exemplary patient access database 30 is illustrated which includes a patient ID number column 32, a username/password column 34 and an accessible ADPI column 36. As the label implies, patient ID number column 32 lists a separate ID number for each patient admitted to the facility. Exemplary patient ID numbers in column 32 include ID number 000219, ID number 902231, etc. Consistent with the example described above, here it is assumed that patient ID number 902231 is associated with patient Edward Mifflin.

Username/password column 34, as the label implies, includes a username and password combination for each of the patient ID numbers in column 32. For example, for patient number 000219 in column 32, username/password column 34 indicates a username “Cindy” and a password “BR374856”. Similarly, for ID number 902231 in column 32, column 34 lists a username and a password as “Edward” and “PI787812”, respectively. Here, it is contemplated that in at least some embodiments, upon intake of a new patient, server 12 is programmed to automatically generate a username and password for use by the admitted patient when accessing ADPI account information. When an admitted patient wants to access his ADPI account information, referring again to FIG. 1, the patient uses a convenient patient interface device 23, 25, etc., to enter the patient's assigned username and password.

Referring still to FIGS. 1 and 2, accessible ADPI column 36, as the label implies, indicates which ADPI account information each patient in column 32 has been authorized to access. For example, an “All ADPI” designation is provided in column 36 corresponding to patient ID number 000219 to indicate that the patient associated with ID number 000219 is authorized to access all information stored in the patient's ADPI account. As another example, a “Non-Test ADPI” designation in column 36 indicates that the patient associated with ID number 902231 in column 32 can access all ADPI account information associated with the patient other than test results. In addition, additional designations in column 36 corresponding to patient ID number 902231 in column 32 indicate that specific test results for Test XX and Test M are accessible to the patient corresponding to ID number 902231. Thus, while the patient corresponding to ID number 000219 can access all ADPI account information associated with that patient, the patient corresponding to ID number 902231 is restricted to a greater degree and, accept for the results corresponding to Tests XX and AA, cannot access test results corresponding to other tests that occur at the facility. Other more restrictive ADPI access rules are contemplated and have not been shown here simply in the interest of simplifying this explanation.

In FIG. 2, while the patient access database is illustrated and described as one wherein the access information is stored as a separate database in the interest of simplifying this explanation, in at least some embodiments it is contemplated that the database may take the form of binary or multi-state flags associated with specific patients and specific information where, when a patient is authorized to access an information subset, the flag may be set to one value and when the patient is not authorized to access information, the flag may be set to another value. Here, in at least some cases, upon discharge or after some period passes, the flags may be automatically reset to block access or to alter the conditions under which access can be had. Similarly, in other embodiments, flags may be set that are associated with specific information subsets to indicate proxy access rights.

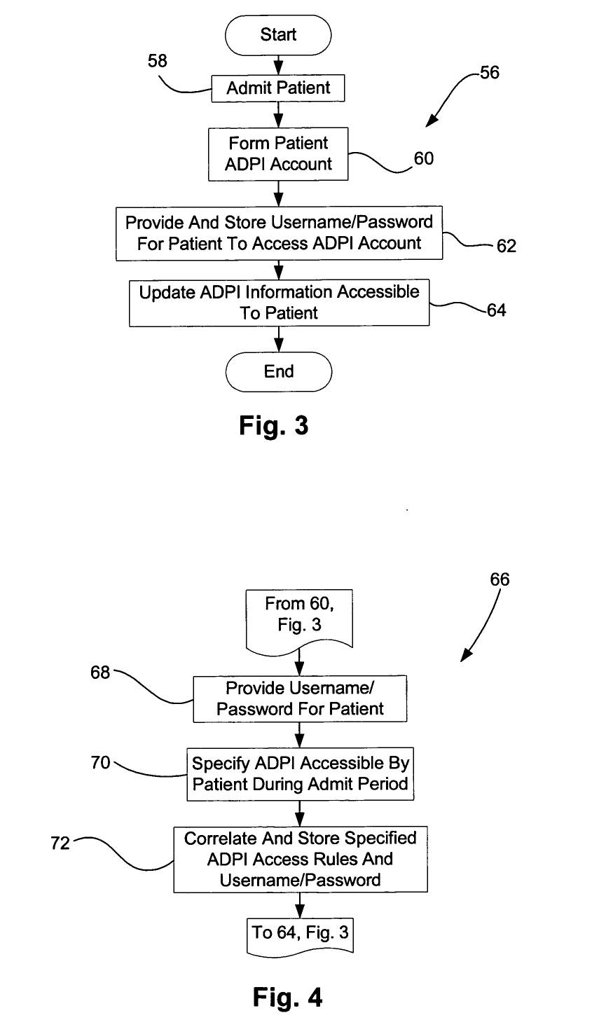

Referring now to FIG. 3, an exemplary method 56 for forming a patient ADPI account and rendering the account accessible by a patient during an admission process is illustrated. Referring also to FIGS. 1 and 2, at block 58 a patient is admitted to facility 15 wherein the facility intake administrator obtains information from the patient and enters the information via interface 16. At block 60, after information has been entered by the intake administrator, server 12 forms a patient ADPI account. At block 62, server 12 generates information corresponding to the newly admitted patient to be added to the patient access database (see again FIG. 2). To this end, server 12 automatically generates a unique patient ID number as well as a username and a password for the newly admitted patient for accessing the patient's ADPI account. At block 62 server 12 may be programmed to provide the username and password to the facility intake administrator to be distributed to the patient.

In the case of method 56 in FIG. 3, it is contemplated that precanned ADPI access rules have been specified that are the same for every newly admitted patient (e.g., each new patient may be allowed to access ADPI account information for the patient, or some subset of all of the ADPI account information and customization of ADPI access rules as a function of patient or patient type is not contemplated). At block 64, during the period over which a patient is admitted to facility 15, ADPI information that is accessible to the patient is updated essentially in real time. Thus, for example, once a new medical image is generated and stored as part of a patient ADPI account, if the patient has been granted the right to access the image, the patient can immediately access the new medical image via one of the patient interface devices.

Referring now to FIG. 4, a submethod 66 that may be substituted for a portion of the method 56 of FIG. 3 is illustrated that enables the facility intake administrator to customize ADPI access rules on a patient-by-patient basis. Referring also to FIGS. 1 and 3, during an admission process and after a patient ADPI account has been formed at block 60, control passes to block 68 where server 12 provides a username and a password for the patient being admitted. At block 70, the facility intake administrator uses workstation 16 to specify which ADPI are to be accessible to the patient during the admit period. To this end, referring also to FIG. 5, an exemplary window view 74 that may be provided by server 12 via workstation display 17 is illustrated. In the illustrated example, window view 74 includes ADPI selecting instructions 76, a patient ID number designation 78, a list 84 of selectable ADPI, a plurality of SELECT icons 82, an ENTER icon 86 and a scrolling icon 88. Instructions 76 instruct the facility intake administrator to select specific ADPI or precanned subsets of ADPI from list 84 that should be accessible by the patient being admitted during the admit period. Patient ID designation 78, as the label implies, provides the patient identification number assigned to the patient being admitted by server 12. List 84 includes selectable ADPI or precanned subsets thereof. For example, list 84 includes an “All ADPI” designation, a “Non-Test ADPI” designation, a “physician's comments” designation, an “Admit Date” designation, a “test results generally” designation, a “visit schedule” designation, a “medication schedule” designation, etc. A separate SELECT icon is provided for and adjacent each ADPI designation in list 84. Mouse controlled pointing icon 21 can be used to select one or more of icons 82. Here, it is contemplated that one or a plurality of SELECT icons 82 is selected by the administrator. When a SELECT icon 82 is selected (e.g., via clicking of a mouse button), the selected icon is highlighted. In FIG. 5, the SELECT icon corresponding to the “Non-Test ADPI” designation in list 84 is shown as highlighted via cross-hatching. Where the space of view 74 is insufficient to accommodate all of the possible ADPI selections. Scrolling icon 86 is useable to scroll up and down within list 84. After a desired subset of the ADPI designations have been selected, ENTER icon 86 is selected to submit the ADPI selections to server 12.

Referring still to FIG. 4 and also to FIG. 2, after ADPI selections have been specified, server 12 correlates and stores the ADPI selections and the username/password in the patient access database 30. In addition, server 12 communicates the username and password in some way to the patient. For instance, in some cases, server 12 will provide the username and password to the administrator during the admission process and the administrator will provide the username and password to the patient. In other cases server 12 may present the username and password to the patient the first time the patient attempts to access ADPI information via one of the patient interface devices (e.g., 23). Other ways this may be done include but are not limited to automatically sending a letter to the patient's address of record with the information; posting a secure message on a patient's medical information account (e.g., a MyChart account as supported by Epic Systems Corporation, placing a phone call to the patient, etc.

In at least some embodiments, in addition to being used to provide information to admitted patients, system 10 may be used to obtain various types of information from patients and to use that information in at least some cases, for other purposes. For instance, patient interface 23 may be used by a patient to memorialize the patient's condition/symptoms as currently perceived by the patient. Here, a physician may be charged with subsequently examining the patients perceptions as part of routine analysis. As another instance, a patient may use interface 23 to generate queries for a physician, to fill out discharge information, to schedule inpatient and post-admission medical appointments, to alter a visitation schedule, to update a patient journal, to track progress on a care plan, to send messages to proxies and/or observers, to make private or other (e.g., distributed to proxies, care providers, etc.) comments related to specific data, to pick a meal, to facilitate instant messaging with proxies, to alter or control proxies/observers, to enter information into a flow sheet, to request medication or assistance, etc. In these cases, in at least some embodiments, it is contemplated that the patient entered information will be stored as one or more separate records in the patient's ADPI account and other applications will access or be fed the information therein.

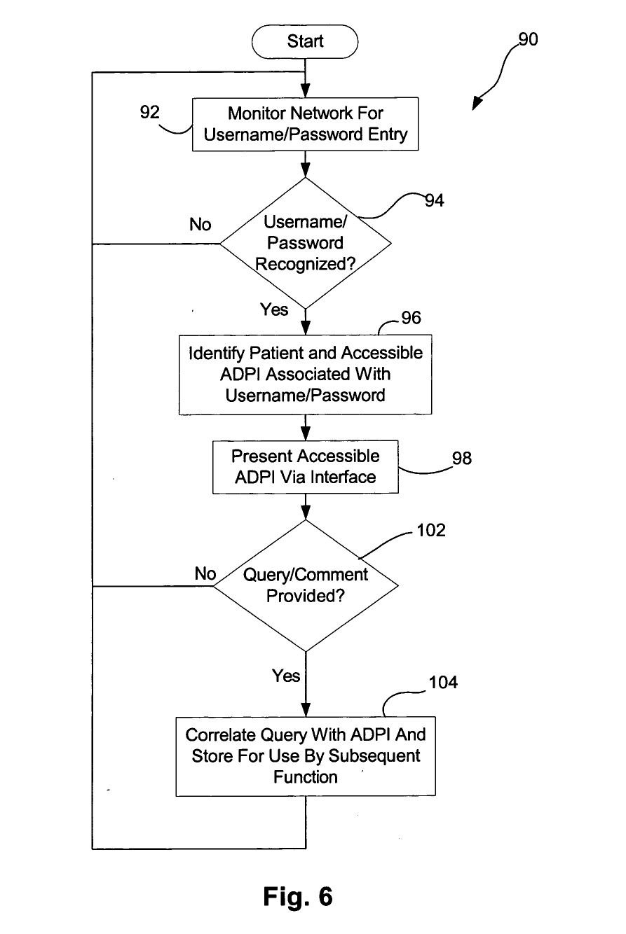

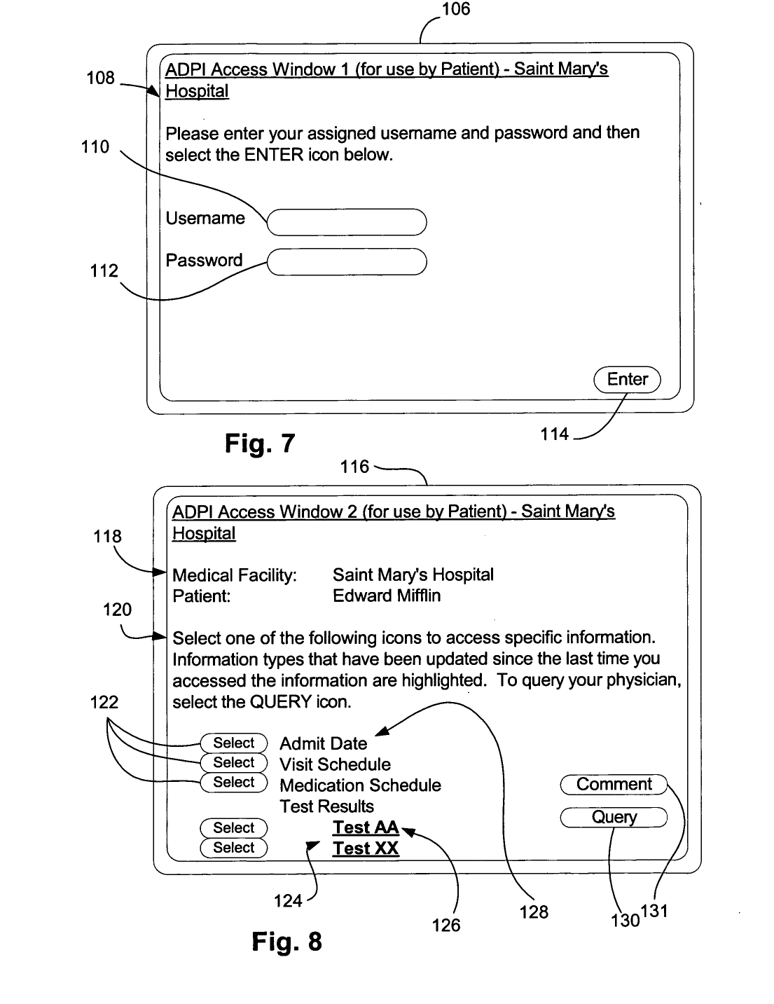

Referring now to FIG. 6, an exemplary method 90 for controlling admitted patient access to an associated ADPI account is illustrated. Referring also to FIGS. 1 and 2, at block 92, server 12 monitors network 28 for attempts by admitted patients to access corresponding ADPI accounts. Referring also to FIG. 7, an exemplary window view 106 that may be provided via patient interface device 23 when an admitted patient wants to access a corresponding ADPI account is illustrate. Window 106 includes instructions 108, username and password fields 110 and 112, respectively, and an ENTER icon 114. Instructions 108 instruct the patient to enter the assigned username and password in fields 110 and 112, respectively. After the username and password have been appropriately entered, the patient is instructed to select ENTER icon 114 to submit the username and password to server 12.

Referring still to FIG. 6, prior to entry of a username and password or after entry of an unrecognized combination of a username and password at block 94, control passes back up to block 92 where monitoring of the network continues. Once a valid username and password combination has been entered at block 94, control passes to block 96. At block 96, server 12 identifies the patient and accessible ADPI associated with the valid username/password combination. To this end, referring also to FIG. 2, server 12 accesses patient database 34. In the present example it will be assumed that the patient associated with ID number 902231 (i.e., Edward Mifflin) has attempted to access his associated ADPI account and therefore the information in database 30 as illustrated in FIG. 2 applies (i.e., the accessible ADPI restrictions apply). Continuing, at process block 98, server 12 presents the accessible ADPI to Edward Mifflin via interface device 23.

Referring also to FIG. 8, an exemplary window view 116 for presenting ADPI account information to Edward Mifflin is illustrated. View 116 includes general information identifying the patient 118, instructions 120, ADPI SELECT icons 122, a list of selectable ADPI types 128, a QUERY icon 130 and a COMMENT icon 131. A separate SELECT icon 122 is provided for each of the ADPI types in list 128. Instructions 120 instruct the patient to select SELECT icons corresponding to ADPI designations that indicate information that the patient would like to access. For example, to select results corresponding to Test M as indicated by text 126, the patient selects the SELECT icon adjacent thereto. Similarly, to access test results for test XX as indicated by text 124, the patient selects the SELECT icon adjacent thereto. When a SELECT icon is selected, server 12 accesses the ADPI account associated with the specific patient, retrieves the ADPI account information corresponding to the selected designation and presents that information for the patient to view.

Referring again to FIGS. 6 and 8, as the patient is analyzing ADPI, the patient may select QUERY icon 130 to generate a question for a specific physician or may select COMMENT icon 131 to memorialize thoughts, perceived conditions, etc. At block 102, when a comment or query is received, control passes to block 104 where the comment or query is stored as a separate ADPI record for subsequent access or to be employed by a subsequently running application (e.g., software employed by a physician while making routing rounds). After block 106, control passes back to block 92 where network monitoring continues.

In at least some embodiments it is contemplated that, for various reasons, at least a subset of ADPI may not be automatically released in real time to patients and, instead, may require affirmative physician activity to be released. For example, a physician may not want to release conclusions related to specific medical images prior to having a conversation with a patient about the ultimate conclusions. Nevertheless, after the conversation occurs, the physician may want to make his conclusions available to the patient. As another example, where a series of ten medical images of a patient have been obtained and only two of the ten include information relevant to a physician's diagnosis, the physician may only want to render two of the ten images accessible to a patient and may want to block patient access to the other eight images to avoid inundating the patient with information and ultimately confusing the patient.

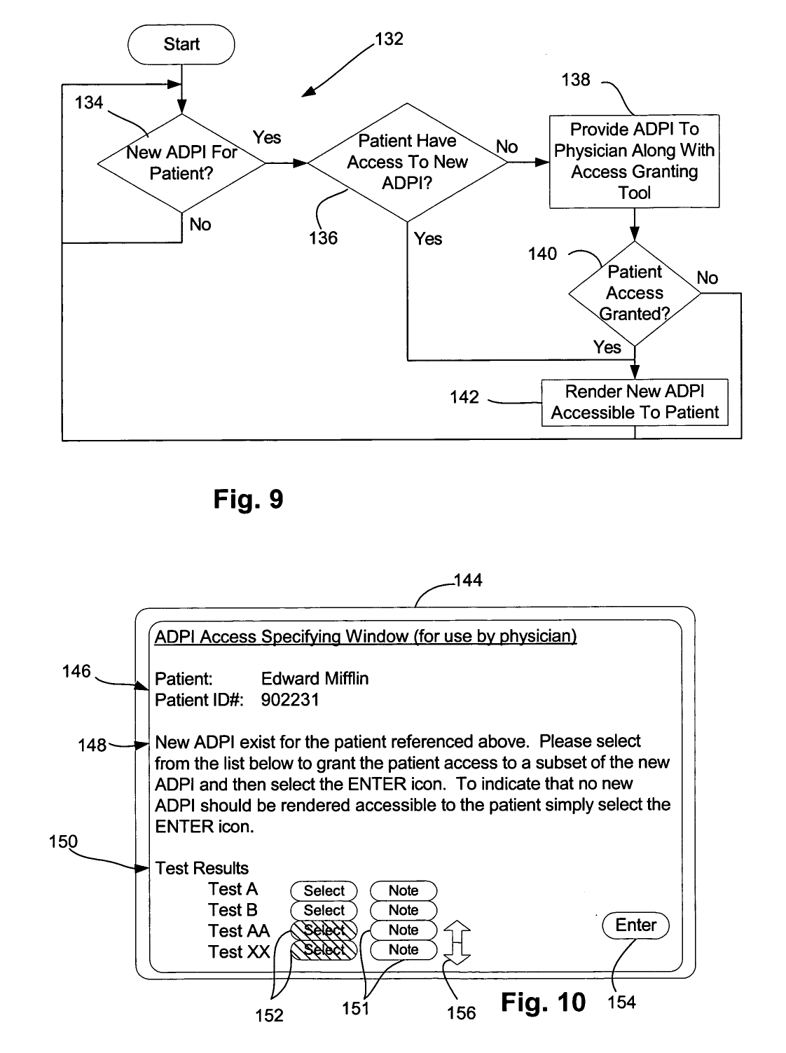

To facilitate timed and preferential release of specific information to patients, in some embodiments of the present invention it is contemplated that server 12 will allow physician's to control release of at least some types of ADPI. To this end, referring to FIG. 9, one ADPI release method 132 is illustrated. Referring also to FIG. 1, at block 134, server 12 monitors network 28 for new ADPI (e.g., modified, updated, newly generated, etc.) associated with specific patients. Where no new ADPI for a patient has been generated, control continues to loop through block 134. Once new ADPI for a specific patient has been generated, control passes to decision block 136 where server 12 determines whether or not the patient already has access to the new ADPI. Where the patient already has access to the new ADPI, control passes from decision block 136 down to process block 142 where the new ADPI is rendered accessible to the patient in a manner similar to that described above. Referring again to decision block 136, where the patient does not already have access to the new ADPI, control passes to block 138 where the new ADPI is provided to the physician along with access granting tools.

Referring now to FIG. 10, a exemplary window view 144 that may be provided to a physician via interface device 18 for granting patient access to specific new ADPI is illustrated. View 144 includes general patient identifying information 146, instructions 148, a list 150 of new ADPI that the patient does not currently have the right to access, separate SELECT icons for each of the ADPI in list 150, separate NOTE icons for each ADPI in list 150, an ENTER icon 154 and a scrolling icon 156. Instructions 148 instruct the physician to select separate SELECT icons 152 for each of the ADPI designations in list 150 that should be rendered accessible to the patient identified by information 146. Here again, multiple SELECT icons 152 can be selected each of which, after being selected, is highlighted (see cross-hatched SELECT icons 152 corresponding to Test AA and Test XX). Scrolling icon 156 can be used to scroll up and down within list 150 where additional new ADPI exist that could not be accommodated within the space of window view 144. To indicate that none of the new ADPI should be rendered accessible to the patient, instructions 148 direct the physician to simply select ENTER icon 154.

Referring again to FIGS. 1 and 9, at block 140, server 12 monitors to determine whether or not patient access to specific ADPI has been granted by the physician. Where the physician has not granted access to specific ADPI, control passes from decision block 140 back up to block 134 where server 12 continues to monitor for new ADPI for the specific patient. At decision block 140, where a physician has granted access to one of the new ADPI, control passes to block 142 where the new ADPI is rendered accessible to the patient. To render the new ADPI accessible to a related patient, referring also to FIG. 2, server 12 modifies the accessible ADPI list for the related patient in column 36 of patient access database 30. After block 142, control passes again back up to block 134.

Although not illustrated it is also contemplated that separate selectable icons may be provided when any ADPI is being viewed by a physician using a device 18, 20, etc., that allows the physician to release the specific ADPI to the associated patient. For instance, while a physician is examining Test AA results via interface device 18, server 12 may provide a RELEASE TO PATIENT icon (not illustrated) adjacent the test results that, when selected, releases the Test AA results to the patient.

In FIG. 10, NOTE icons 151 are selectable to enable the physician to attach a note to any one of the ADPI in list 150. Here, in at least some embodiments all attached notes may be for the physician only to subsequently access or may be for dissemination to the patient when an associated ADPI is released or, in some cases, the physician may be able to select if notes are disseminated with associated ADPI or are not released.

In addition to or instead of enabling admitted patients to access at least subsets of ADPI account information, according to at least some inventive embodiments, representatives or proxies for patients or observers can also be granted access rights to at least subsets of ADPI account information for specific patients. For example, parent Jeanne Mifflin of teenage patient Edward Mifflin may be granted access rights to more, all or a subset of the ADPI account information that Edward Mifflin has access to and may be able to access that information either within admitting facility 15 or remotely using one of the remote interface devices such as device 22 (see again FIG. 1). Here, in at least some cases it is contemplated that a patient would have to agree to grant proxy access rights to access ADPI accounts or subsets of ADPI account information. In other cases, it is contemplated that persons may be able to apply for proxy access such as, for instance, in the case of the parent of a teenage patient.

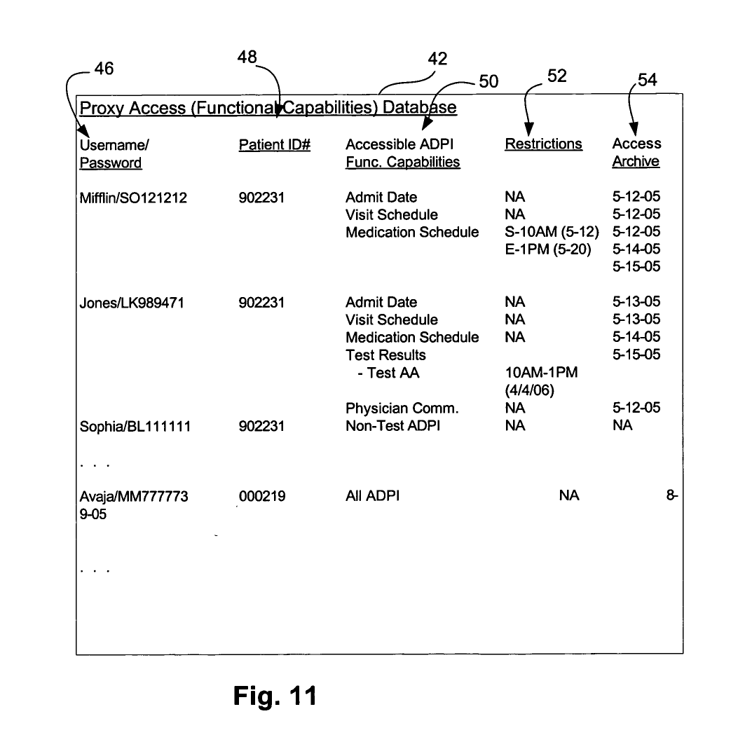

Referring now to FIG. 11, an exemplary proxy access database 42 that may be formed and populated by server 12 to facilitate proxy access to ADPI accounts is illustrated. Database 42 includes a proxy username/password column 46, a patient ID number column 48, an accessible ADPI column 50, a restrictions column 52 and an access archive column 54. As the label implies, username/password column 46 lists a separate username and password combination for each proxy that has access to any ADPI account information stored on database 14 (see FIG. 1). An exemplary first username/password combination in column 46 includes the username “Mifflin” and the password “SO121212” which, it will be assumed, has been assigned to Jeanne Mifflin. A second exemplary username and password combination in column 46 includes username “Jones” and the password “LK989471”.

Referring still to FIG. 11, patient ID number column 48 lists a patient ID number for each of the username/password combinations that occurs in column 46. Here, each patient ID number provided in column 48 corresponds to a specific admitted patient for which the proxy associated with the username and password combination in column 46 has been granted at least some ADPI access rights. For example, patient ID number 902231 in column 48 corresponds to the username and password combination including username “Mifflin” and password “SL121212” in column 46. Referring also to FIG. 2, it should be appreciated that patient number 902231 corresponds to a single specific admitted patient (in this case Edward Mifflin). Referring still to column 48, it should also be appreciated that, in at least some embodiments, multiple proxies can be granted access rights to ADPI account information for a single patient. To this end, patient ID number 902231 is listed three separate times in column 48, each separate instance of ID number 902231 corresponding to a different username/password combination in column 46. The three instances of ID number 902231 indicate that three separate proxies have been granted access rights to access at least some ADPI account information corresponding to the patient associated with number 902231.

Referring yet again to FIG. 11, accessible ADPI column 50 includes ADPI designations for each of the patient ID numbers in column 48. In the present example, different subsets of ADPI designations are provided in column 50 for each of the patient ID numbers in column 48 which indicates that the proxies associate with the username and password combinations in column 46 have different ADPI account access rights (i.e., each proxy has the right to access a different subset of ADPI). For instance, the proxy associated with the username and password combination Mifflin/SO121212 has the right to access ADPI including the admit date, visitation schedule and medication schedule for the patient associated with ID number 902231. In contrast, the proxy associated with the username and password combination Jones/LK989471 has the right to access ADPI including the admit data, visitation schedule, medication schedule, test results for test AA and physician comments for the patient associated with patient number 902231.

Referring to FIG. 11, restrictions column 52 indicates any restrictions on accessing ADPI in column 50. For example, column 52 indicates that the proxy associated with the username and password combination Mifflin/SO121212 can only access the medication schedule for the patient associated with ID number 902231 between 10 A.M. on May 12 and 1 P.M. on May 20 and will be blocked from accessing that information at other times. A “NA” designation in column 52 indicates that there are no restrictions on access to a specific associated ADPI in column 50. Other restriction types are contemplated and have not been illustrated in FIG. 11 in the interest of simplifying this explanation. For instance, other ADPI access restrictions may include limiting ADPI access to one or a small number of times, only allowing access after a physician affirmatively authorizes access, only allowing access to current/updated ADPI, only allowing access after a patient affirmatively authorizes access, etc.

Column 54 includes information that indicates when specific ADPI in column 50 have been accessed. Thus, for instance, column 54 indicates that the proxy associated with the username/password combination Mifflin/SO121212 accessed the medication schedule related to the patient associated with patient ID number 902231 three separate times on May 12, 2005, May 14, 2005 and May 15, 2005. Once again, an “NA” designation in column 54 indicates that an associated ADPI in column 50 has not been accessed by a proxy. The archive access information would likely be more detailed and include access time, duration, identification of information accessed, etc.

Referring yet again to FIG. 11, although the proxy information is described herein as being stored as a separate database 42, it should be appreciated that the proxy information may instead be stored along with associated informal records as a series of flags and/or a plurality of relational databases. For instance, a record indicating that the proxies associated with the user name/password combinations Mifflin/S0121212 and Jones/LK989471 have access to the patient information associated with ID numbers 902231 may be stored with the admit date, visit schedule, test results, etc. Here, when a proxy attempts to access patient information, software examines the stored records to identify accessible information and assembles the information accordingly.

While FIG. 11 is described in the context of information accessibility, it should be appreciated that, in at least some embodiments, database 42 may be replaced by an access/entry/control database (not illustrated) that, in addition to specifying access and restriction rights related to the patient information, also specifies whether or not proxies can enter information to be memorialized and whether or not proxies have the ability to control certain system features or to facilitate functional capabilities. For instance, in some cases at least a subset of proxies may be able to enter information via a proxy device such as notes or flags that can be associated with specific inpatient information. The notes may be solely for use by the proxy and therefore, while memorialized may not be disseminated to the related patient, the patient's physician, other proxies, etc. In the alternative, the notes may be intended for and distributed to any subset of the associated patient, physician, other proxies/observers, etc.

As another instance, in some cases, proxies may have the ability to act on behalf of an associated patient. For example, a proxy may have authority to set up post inpatient medical appointments for a patient, to change a visitation schedule, to alter a meal choice, etc.

As yet another instance, in at least some cases, it is contemplated that a proxy may have the ability/right to alter other proxy and/or observer's rights. For example, a primary proxy (e.g., Edward Mifflin's mother Jeanne) may have the ability to authorize Edward's father Tom and others to have proxy access rights to access and/or control/enter information on behalf of Edward. As another example, a primary proxy may have the ability to authorize others to be observers that can access certain information related to an admitted patient. Here, in at least some embodiments it is contemplated that proxy rights to control other proxies may be limited while in other cases a proxy may be able to authorize other proxies to have the same rights as the granting proxy. In addition, while some embodiments may facilitate pre-canned proxy granting rights and restrictions (e.g., in some cases proxies may be limited to family members or significant others), in other cases proxies may be able to tailor specific access/control/entry rights of other proxies/observers.

In at least some embodiments a proxies ability to control other proxy/observer rights as well as to enter information/control other features/functions may be precanned. In other embodiments a proxies ability to control other proxy/observer rights as well as to enter information/control other features/functions may be settable or selectable by a patient and/or a physician.

In the above cases, referring again to FIG. 11, it is contemplated that column 50 may include entry/control information for each or at least a subset of the username/password combinations in column 46. Column 50 includes sublabel “Func. Capabilities” to indicate that functional capabilities may be specified there. In light of the present specification one of ordinary skill in the art should be able to configure software and suitable interface screen shots to help a patient or administrator specify proxy access and functional capabilities and to help a primary proxy specify access and functional capabilities for other proxies and/or observers.

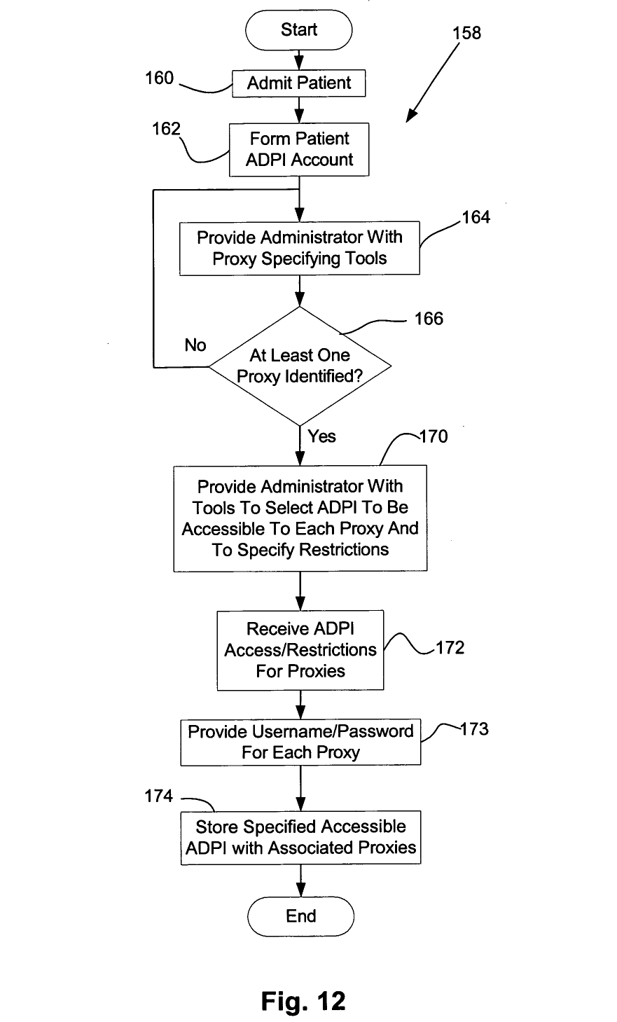

Referring now to FIG. 12, an exemplary method 158 for enabling proxy access to at least a subset of the information in a patient's ADPI account during an admission process is illustrated. Referring also to FIG. 1, at block 160, the facility intake administrator receives information from a patient being admitted and performs a patient admission process. At block 162, after initial patient information has been entered via workstation 16, server 12 forms a patient ADPI account and stores that account in database 14. At block 164, server 12 provides the administrator with proxy specifying tools.

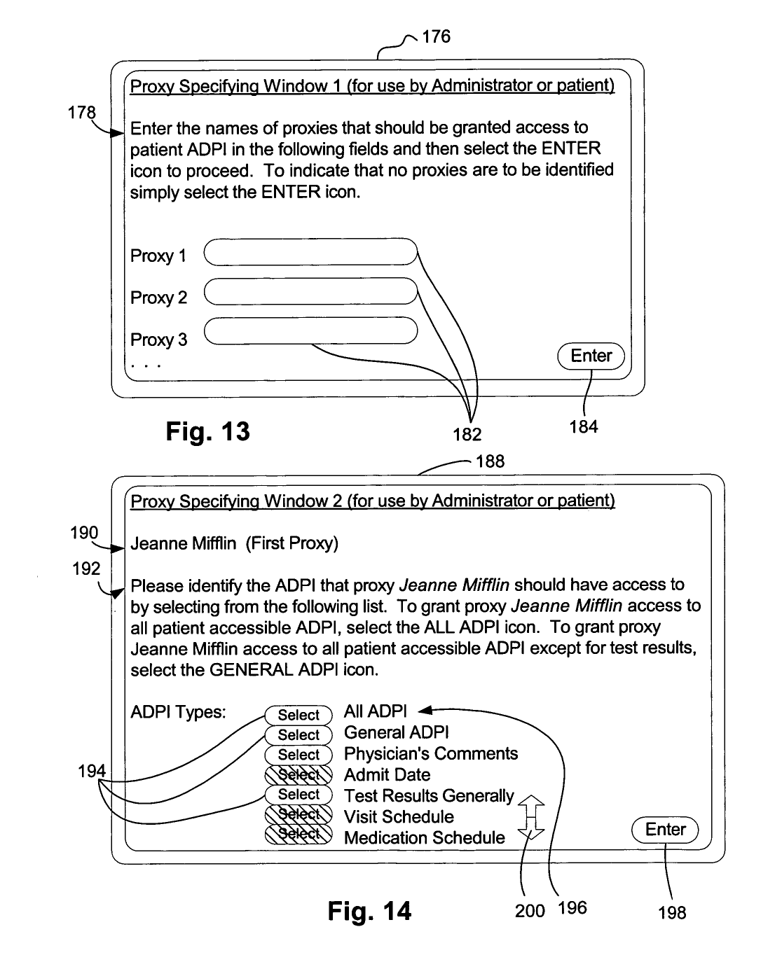

Referring also to FIG. 13, an exemplary window view 176 for identifying proxies is illustrated. View 176 includes instructions 178, fields 182 for entering the names of proxies and an ENTER icon 184. The instructions 178 instruct the administrator to enter the names of persons to be granted proxy access in fields 182 and to then select ENTER icon 184 to submit the proxy names to server 12. Here, it is contemplated that upon being admitted to the facility, a patient will give the names of intended proxies to the administrator for entry into fields 182.

Referring still to FIGS. 1 and 12, at block 166, where at least one proxy has been identified, control passes to process block 170 where server 12 provides the administrator with tools to select ADPI that are to be accessible by each of the identified proxies. Where proxies may also be able to enter information and/or control functions (e.g., schedule appointments, specify other proxies/observers, etc.), specification of these types of features also would occur at block 170 and subsequent blocks. To this end, referring also to FIG. 14, an exemplary window view 188 to help the administrator specify accessible ADPI is illustrated. Window 188 includes a proxy identifier 190, instructions 192, a list of potential accessible ADPI 196, a SELECT icon 194 for each designation in list 196, an ENTER icon 198 and a scrolling icon 200. Proxy identifier 190 identifies one of the proxies that was specified at process block 164. In the present example, identifier 190 identifies proxy Jeanne Mifflin. Instructions 192 instruct the administrator to select SELECT icons corresponding to each ADPI in list 196 to which the proxy is to be granted access. Again, as SELECT icons 194 are selected, the icons are highlighted (e.g., see cross-hatching in FIG. 14). After a subset of the SELECT icons 194 has been selected, the administrator is instructed to select ENTER icon 198 to submit the selections to server 12. Scrolling icon 200 can be used to scroll through the ADPI list 196 where the space provided by view 188 is insufficient to accommodate all of the possible ADPI selections.

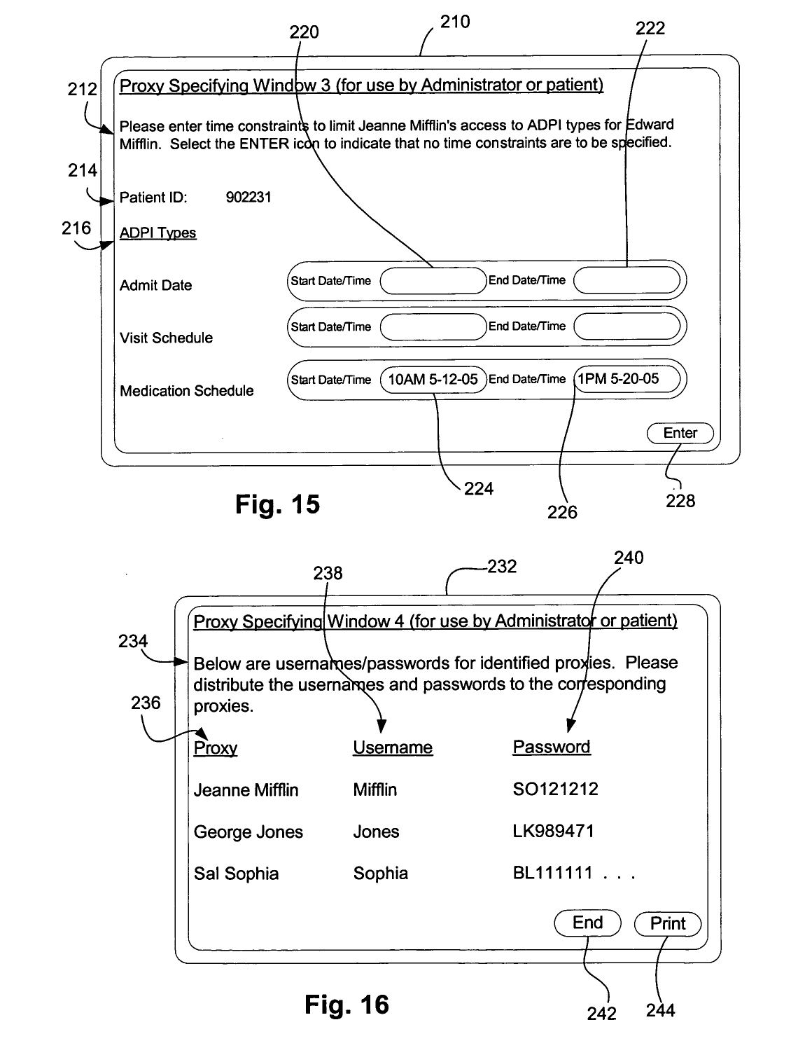

Referring still to FIG. 14 and also to FIG. 15, when ENTER icon 198 is selected, server 12 may be programmed to provide yet another window view 210 for specifying time and/or other restrictions for accessing ADPI types. To this end, view 210 includes instructions 212, a patient identifier 214, a list 216 of ADPI types selected by the administrator via window view 188 (see again FIG. 14) and start and end fields for each selected ADPI type. Exemplary list 216 includes admit date, visit schedule and medication schedule. Start and end fields corresponding to the admit date ADPI type are identified by numerals 220 and 222. Similarly, start and end fields corresponding to the medication schedule ADPI type are identified by numerals 224 and 226, respectively. Instructions 212 instruct the administrator to enter start date and time as well as end date and time information into the start and end fields for any of the ADPI types in list 216 for which access is to be temporarily limited. In the example, information has been inserted into fields 224 and 226 corresponding to the medication schedule ADPI type in list 216 where the entered information is consistent with the information in column 52 of FIG. 11. After start and end information has been entered for any ADPI types that are to be temporarily restricted, the administrator is instructed to select ENTER icon 228 to submit the information to server 12 where other restriction types are contemplated, a similar restriction specifying process would be supported. The process of specifying proxy specific accessible ADPI and ADPI restrictions is repeated for each separate proxy.

In at least some cases where proxies have access to personal medical web portals such as a MyChart portal as supported by Epic Systems Corporation (see U.S. patent application Ser. No. 09/821,615 that is titled “Patient Health Record Access System” that was filed on Marcy 29, 2001 and that is incorporated herein in its entirety by reference) and where the proxies have been pre-designated or can be automatically or manually associated with specific patients, then release of a user name and password could be done automatically to the proxy's existing MyChart account via transmission of a secure message to the proxy's account such as “You have been given proxy access to a subset of x's inpatient information—your user name is xxx and your password is yyy.”

Referring still to FIGS. 1 and 12, after block 172, control passes to block 173 where server 12 automatically generates usernames and passwords for each of the designated proxies. Referring also to FIG. 16, an exemplary window view 232 that may be provided to the administrator via server 12 to indicate assigned usernames and passwords is illustrated. To this end, view 232 includes instructions 234 and three columns of correlated information including a proxy column 236, a username column 238 and a password column 240. As the label implies, proxy column 236 lists each of the designated proxies. Consistent with the example above, one of the proxies in column 236 includes Jeanne Mifflin. Username column 238 includes a separate username for each of the proxies in column 236. For example, the username corresponding to proxy Jeanne Mifflin in column 236 is “Mifflin”. Column 240 includes a unique password for each of the proxies in column 236. Consistent with the present example, the password associated with username “Mifflin” in column 238 is SO121212 in column 240. Instructions 234 instruct the facility intake administrator to distribute the usernames and passwords to the corresponding proxies. Here distribution may include simply providing the username and password combinations to the patient so that the patient can distribute the usernames and passwords to the corresponding proxies. In the alternative, as part of the admission procedure, the administrator may obtain contact information for each of the proxies and may be charged with distributing the usernames and passwords accordingly.

Referring yet again to FIGS. 1 and 12 and also to FIG. 11, after block 173, control passes to block 174 where server 12 stores the specified proxy ADPI and restriction information in proxy access database 42 for subsequent use.

In at least some inventive embodiments it is contemplated that, in addition to obtaining the names of proxies during an admitting process, the facility intake administrator may also obtain e-mail addresses for designated proxies if the patient has such information available. Where e-mail addresses are obtainable, the process of distributing usernames and passwords to proxies and of notifying proxies that a patient has been admitted to a facility can be streamlined. In this regard, referring again to FIG. 12, where e-mail addresses are obtainable, process block 164 may include providing tools for entering proxy e-mail addresses as well as proxy names.

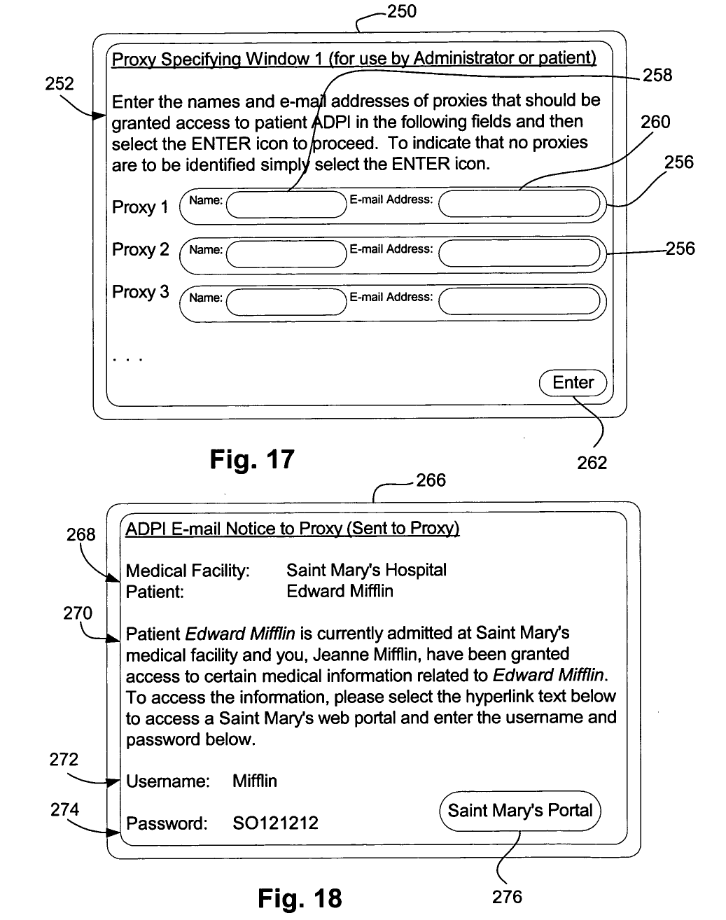

Referring also to FIG. 17, an exemplary window view 250 for entering proxy names and addresses is illustrated. View 250 includes instructions 252, correlated pairs 256 of fields for entering proxy names and e-mail addresses and an ENTER icon 262. Exemplary correlated field pair 256 includes a name field 258 and an e-mail address field 260 in which a proxy name and the proxy's e-mail address are to be entered, respectively. After proxy names and e-mail addresses are entered in the field pairs, instructions 252 instruct the administrator to select ENTER icon 262 to submit the specified information to server 12 (see again FIG. 1).

In this case, referring still to FIG. 12, instead of providing usernames and passwords to the system administrator for distribution, server 12 may be programmed to automatically e-mail notice of patient admission along with a proxy's username and password to each of the designated proxies at process block 173. To this end, an exemplary e-mail notice 266 to be transmitted to a designated proxy is illustrated in FIG. 18. Notice 166 includes information 268 that identifies a patient and the facility to which the patient has been admitted, instructions 270, the username and password assigned to the specific proxy 272 and 274, respectively, and a hyperlink icon 276 to a facility portal. Instructions 270 inform the proxy that the patient identified by information 268 has been admitted to the medical facility. The instructions 270 also inform the proxy that the proxy has been authorized to access at least some ADPI account information associated with the admitted patient. Moreover, instructions 170 indicate that the proxy can access the ADPI account information by selecting icon 176 and using the username 272 and password 274 to access the information. Here, when icon 276 is selected, in at least some embodiments, it is contemplated that server 12 will provide an ADPI access window similar to window view 106 illustrated in FIG. 7 for entry of the proxy's username and password.

Although not separately illustrated, a process akin to method 90 in FIG. 6 which is described above is performed by server 12 in at least some inventive embodiments to monitor when a proxy attempts to access ADPI account information and to facilitate the accessing process. Here, proxy access is limited by the information specified in proxy access database 42 (see again FIG. 11). Consistent with FIG. 11, for example, when proxy Jeanne Mifflin that is associated with the username and password combination Mifflin/SO121212 uses a remote interface device 22 to access information related to the patient associated with ID number 902231 (i.e., Edward Mifflin), a window view 280 illustrated in FIG. 19 may be provided by server 12 which include facility and patient information 282, instructions 284, SELECT icons 286 and an ADPI list 288 that lists ADPI types that the proxy has the authority to access. Instructions 284 instruct the proxy to use SELECT icons 286 to select specific ADPI types to be accessed.

In at least some embodiments is it contemplated that admitted patients will be able to grant or modify proxy access in addition to or instead of the administrator being able to grant and/or modify proxy access. To this end, after a patient is admitted to a facility, in at least some embodiments, the patient may access one of the patient interface devices 23, 25, etc. and grant or modify proxy access.

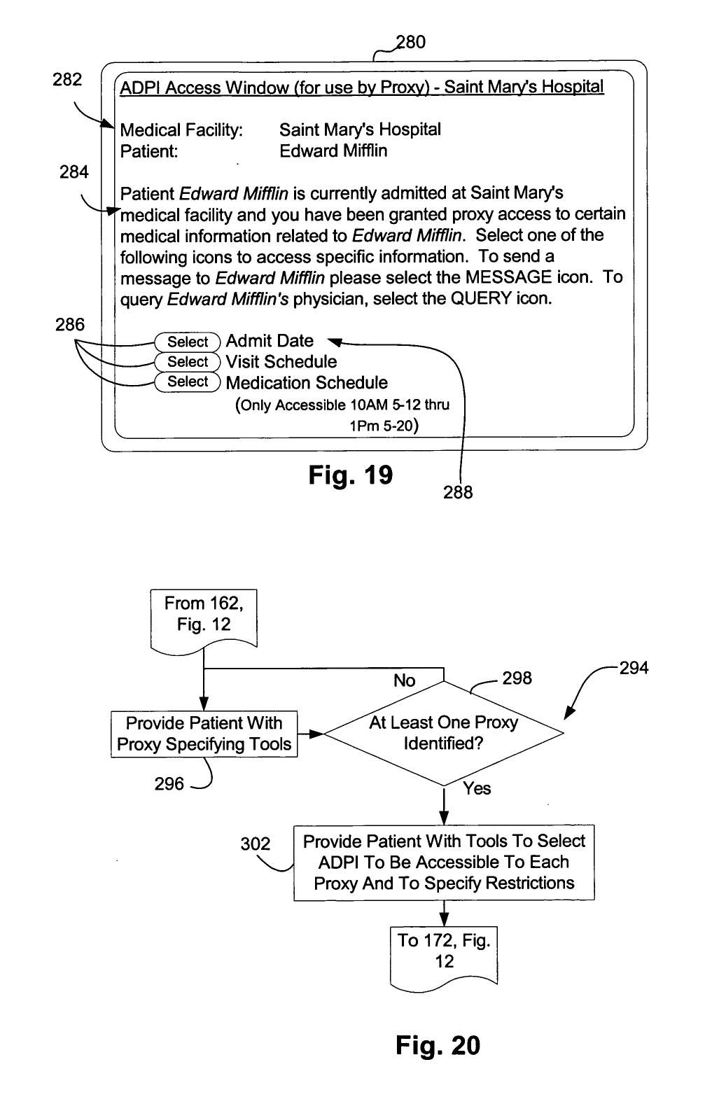

Referring now to FIG. 20, an exemplary submethod 294 that may be substituted for a portion of the method illustrated in FIG. 12 to enable a patient to grant or alter proxy access is illustrated. Referring also to FIGS. 1 and 12, after server 12 forms a patient ADPI account during the admission process at block 162, control passes to block 296 where the patient uses an interface device 23 to access proxy specifying tools. Here, as in the case of the administrator, the specifying tools may include window views akin to view 176 in FIG. 13 or view 250 in FIG. 17. After at least one proxy is specified by the patient at block 298, control passes to block 302 where server 12 provides the patient with tools to select ADPI to be accessible by each of the proxies designated by the patient and also to specify restrictions on ADPI access (as well as proxy entry/control capabilities where the system supports such functionality). Here, the tools provided at block 302 may include window views akin to the view illustrated in FIGS. 14 and 15 or other views where additional restriction types are contemplated. After block 302, control passes back to block 172 in FIG. 12 where the process described above is completed. Where a patient can grant/alter proxy access authority, it is contemplated that the patient would only be able to grant access to ADPI that the patient himself has authority to access. Thus, for instance, where a patient does not have the authority to access physician comments/conclusions regarding a set of medical images, the patient would not have the ability to grant such access to a proxy.

As described above, in at least some embodiments it is contemplated that at least a subset of proxies may have the ability to grant and/or modify access/functional capabilities of other proxies/observers instead of, or in addition to, the patient and/or an administrator. To this end, it is contemplated that at least a primary proxy may have the ability to access screens akin to screens illustrated in FIGS. 13-15 for granting/modifying proxy/observer access. Once again, there may be restrictions on who a proxy can grant access/functional capabilities to and the information and functional capabilities that can be granted. In addition, in at least some cases, when proxy/observer access/functional capabilities are modified by a proxy (or, in at least some cases, by an administrator), a notice may be provided to the patient.

In at least some embodiments it is contemplated that proxies may want to obtain notice whenever information they have the right to access is updated. For instance, in the present example, Jeanne Mifflin may want immediate notice whenever the medication regiment for her son Edward is altered. As another instance, Jeanne Mifflin may want immediate notice whenever a new test procedure is scheduled or when test results for a specific procedure are completed for Edward.

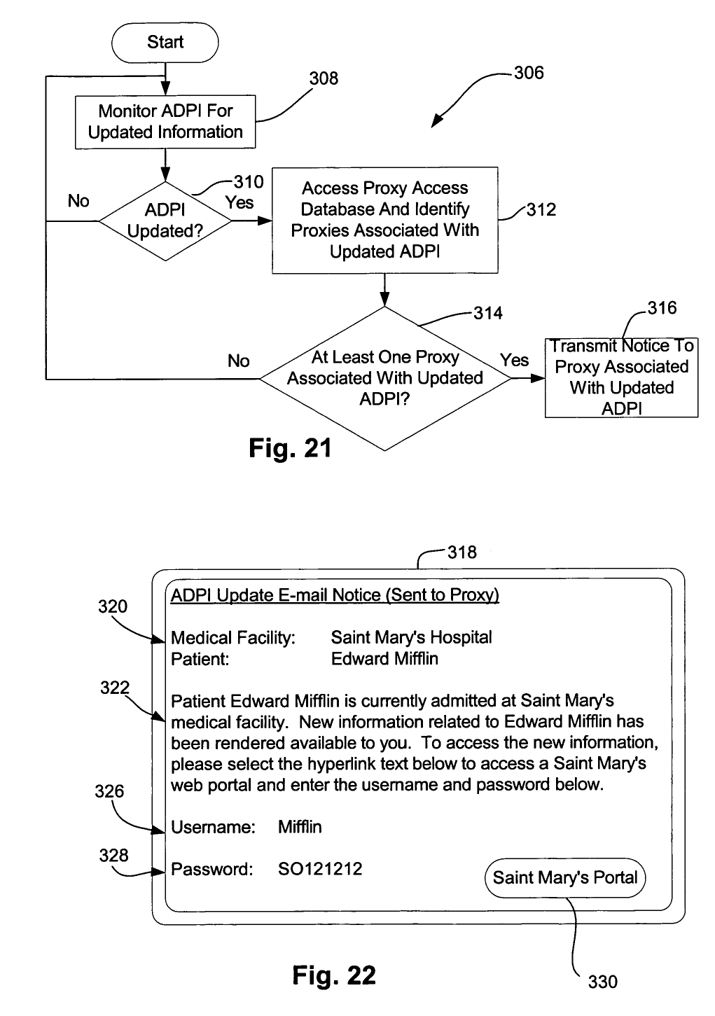

According to one aspect of at least some embodiments of the present invention, server 12 may be programmed to monitor ADPI updates and to provide immediate notice to proxies that have access rights to related ADPI. To this end, an exemplary method 306 consistent with at least some inventive embodiments is illustrated in FIG. 21. Referring also to FIG. 1, at block 308 server 12 monitors ADPI on network 28 for updated information. At block 310, monitoring of the network continues until ADPI is altered after which control passes to process block 312. At block 312, server 12 accesses the proxy access database illustrated in FIG. 11 and identifies proxies associated with the updated ADPI. To this end, server 12 identifies the patient ID number associated with the updated ADPI as well as the ADPI type and tries to identify a proxy associated with the patient ID and accessible ADPI combination. At block 314, where no proxy is associated with the updated ADPI, control passes back up to block 308 where the process described above is repeated. However, if at least one proxy is associated with the updated ADPI at block 314, control passes to block 316 where server 12 transmits notice to the proxy associated with the updated ADPI.

Referring to FIG. 22, an exemplary e-mail notice 318 that may be provided to a proxy associated with an updated ADPI is illustrated. Notice 318 includes general information 320 that identifies the patient and the facility at which the patient is admitted, instructions 322, the username and password 326 and 328, respectively, to be used to access the patient's ADPI and a selectable hyperlink icon 340 for accessing the facility's portal.

While the invention may be susceptible to various modifications and alternative forms, specific embodiments have been shown by way of example in the drawings and have been described in detail herein. However, it should be understood that the invention is not intended to be limited to the particular forms disclosed. For example, according to another aspect that is consistent with at least some aspects of the present invention, whenever a proxy accesses any ADPI associated with a specific admitted patient, server 12 may be programmed to provide notice to the patient of the access and specific information related thereto such as which information was accessed, who accessed the information, the time the information was accessed, etc.

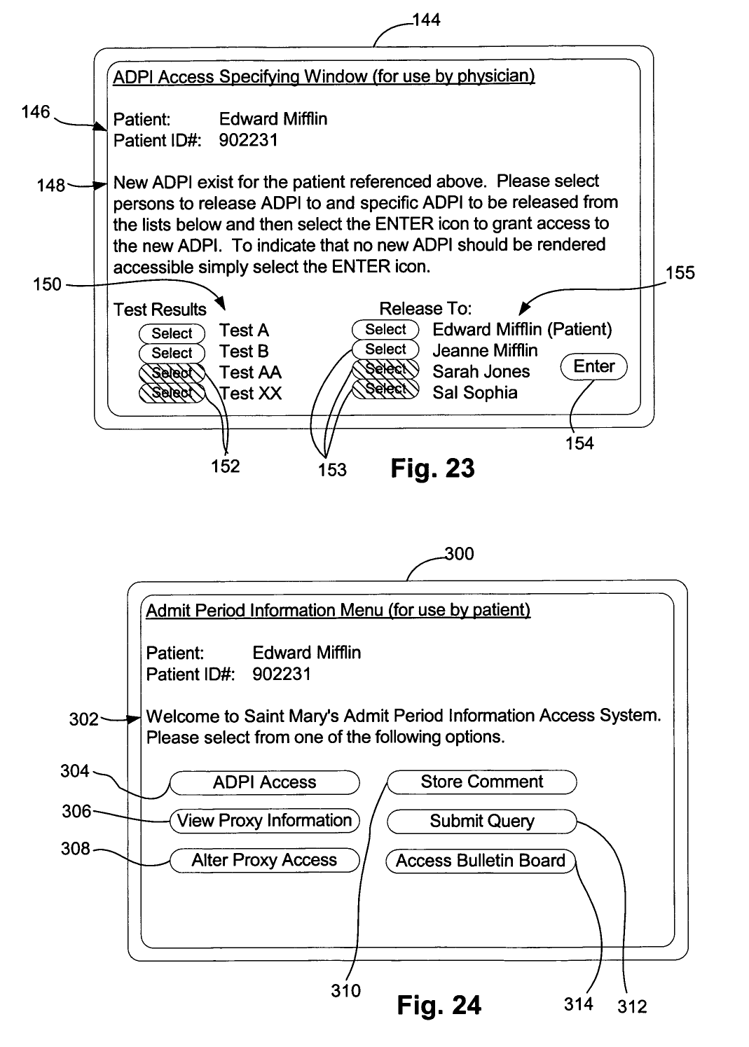

In addition, while one method is described above wherein a physician can affirmatively grant access to certain ADPI types for a patient to view, in at least some embodiments it is contemplated that the physician may also be able to affirmatively grant access to proxies to specific ADPI types or specific ADPI. Here, a process similar to that described above with respect to FIG. 9 is contemplated. For instance, referring to FIG. 23, a window view similar to the view illustrated in FIG. 10 is illustrated where, in addition to general information 146, instructions 148, a list 150 of new ADPI, SELECT icons 152 and an ENTER icon 154, the view also includes a list 155 of possible persons to which ADPI may be released as well as a separate SELECT icon 153 for each person in list 155. Here, the instructions instruct a physician to select persons from list 155 to which ADPI should be released as well as how to select ADPI to be released. After selection, when ENTER icon 154 is selected, the selected ADPI are rendered accessible to the selected person(s) from list 155. Similarly, in at least some embodiments, this may also be done by a proxy that has the authority to release specific information to other proxies and/or observers.

Similarly, in at least some embodiments it is contemplated that the patient may be able to affirmatively grant proxy access to certain types of ADPI using a process similar to that described above with respect to FIG. 9. Thus, for instance, when particularly sensitive test results are stored as part of a patient's accessible ADPI, the patient may be able to decide, after viewing the posted test results, whether or not that information should be released to proxies and which proxies to release the information to.

In addition, while a method is described above with respect to FIG. 10 wherein a physician can add notes to new ADPI prior to rendering the ADPI accessible to a patient, in other embodiments a physician is able to attach notes to new ADPI in a similar fashion prior to rendering the ADPI accessible to patient proxies. Similarly, in other embodiments a physician and/or a patient is provided window views that allow the patient and/or physician and/or a proxy to attach notes to previously examined (e.g., “old”) ADPI and/or to render previously examined ADPI accessible to specific proxies, the patient, physicians, etc. Each of these variations should be simple to implement by one of ordinary skill in the art given the above teachings.

Moreover, while an embodiment is described above with respect to FIG. 8 wherein a patient can generate a comment or a query to be stored as part of an ADPI account for subsequent use, in at least some embodiments it is contemplated that proxies will be provided similar memorializing tools. Along these same lines, in at least some cases it is contemplated that each of a patient, proxies, physicians, etc., may be provided tools for messaging back and forth (e.g., message board capabilities, instant messaging, etc.).

In addition, in at least some cases it is contemplated that server 12 may also enable inpatients to perform other software related processes and/or functions such as scheduling appointments, filling out discharge information forms, defining visitation schedules, altering meal options, receive and start post-admit patient care plans, review discharge instructions, maintain a journal, track progress, on a care plan, send a message to the doctor, send a message to proxies, send a message to a bulletin board, make private comments on data, make comments on data that are to be shared with proxies, make comments on data for organization/healthcare providers, instant messaging; proxy control/administration; entering flow sheet data; requesting medication, requesting assistance; setting up a visitation schedule, etc.

Moreover, while a method has been described above wherein proxy access to ADPI is customizable by a facility intake administrator or by a patient, in at least some embodiments it is contemplated that proxy access may be precanned for all proxies so that proxies can only obtain certain types of information or, proxy access may be precanned for certain case types and the precanned specification may be different for different case types. For instance, the precanned access for a cancer patient may be different than the precanned access specification corresponding to a woman that has been admitted to give birth.

In other cases, there may be two or more precanned ADPI access rule sets for patients. For instance, a patient may want one close relative or friend to have extensive access to ADPI and a group of others to have more limited access. Here, two precanned proxy rule sets may be specified, one for extensive access and to facilitate functional capabilities and one for more limited access. Where multiple proxies are to have the same access rights, one username/password combination may be distributed to each of the proxies.

Furthermore, while a method has been described above wherein notice of ADPI is automatically transmitted to proxies, in at least some embodiments it is also contemplated that notice of ADPI updates may automatically be provided to a patient via one of the patient interface devices or some other device type.

In addition, while the embodiments described above are described in the context of a system that maintains ADPI in patient specific accounts, it should be appreciate that in at least some embodiments patient specific ADPI accounts may not be maintained and, instead, whenever ADPI is to be accessed by a patient or proxy, server 12 may be programmed to identify the ADPI types to be accessed and to cobble together ADPI that is stored in various accounts or databases to form suitable ADPI records for distribution.

Moreover, instead of specifying proxy or patient access by selecting ADPI to be accessible, in at least some cases it is contemplated that tools will be provided for selecting ADPI that should not be accessible. For instance, while Edward Mifflin may want his mother to be able to generally access his ADPI, Edward may want to block access to the fact that certain tests have been performed or test results. Here, a tool may be provided for selecting specific ADPI to be restricted.

In addition, a general patient ADPI menu is contemplated. In this regard, see the view 300 in FIG. 24 that may be provided after a patient first logs onto the system. View 300 includes instructions 302 and selectable icons 304, 306, 208, 310, 312 and 314 for accessing at least a subset of the patient useable tools described above. The icons 304, 306, 308, 310, 312 and 314 allow ADPI access, examination of current proxy authority, entry of comments, entry of general queries and access to an electronic bulletin board for messaging between the patient and associated proxies, respectively. A similar ADPI menu may be provided for proxies upon log on.

Moreover, while the invention is described in the context of a situation where a patient is competent, cognizant and of legal age, it should be appreciated that in other circumstances where a patient has a legal representative, the concepts described above would be applicable to the legal representative irrespective of whether or not the patient granted legal authority to act on his behalf. In this regard, in the claims that follow, when the term “patient” is used, that term is meant to cover patients and/or legal guardians or representatives.

In addition, while a proxy access archive concept has been described above for tracking and storing proxy access information, it should be appreciated that a patient's access may also be archived and stored in a similar fashion. Where patient access is tracked and stored, a facility administrator or the patient himself could subsequently examine which information was examined, when the information was examined, etc.

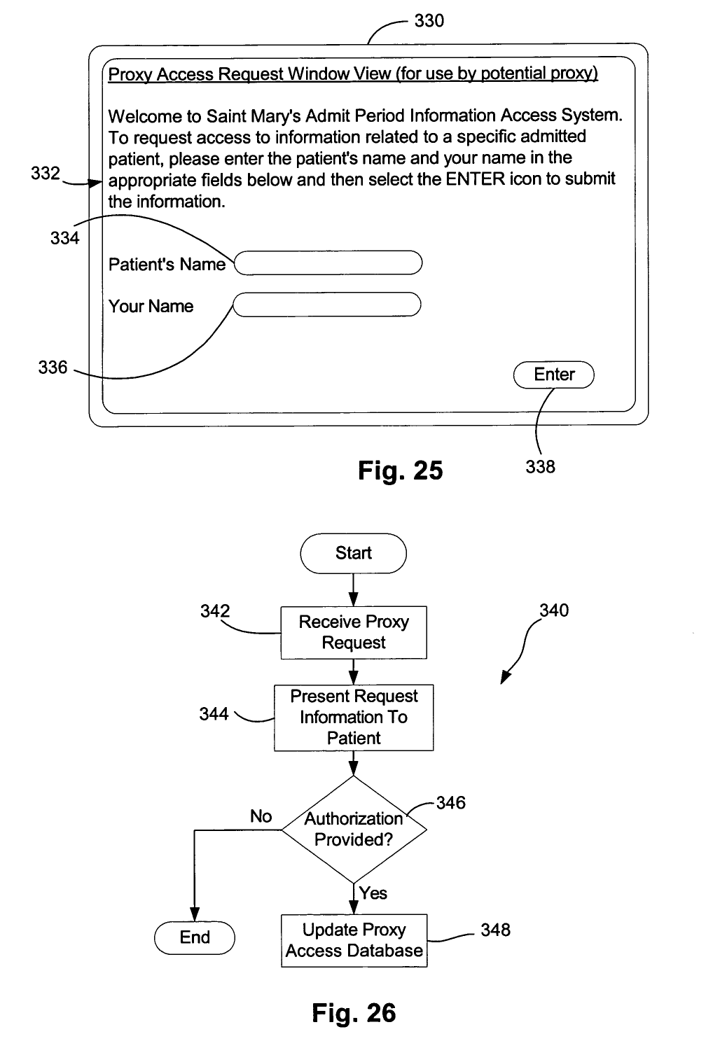

Furthermore, in at least some cases it is contemplated that a potential proxy may request access to an admitted patient's information. Here it is contemplated that in at least some cases access may be granted based on a pre-existing and verifiable relationship between a patient and a potential proxy after which access would be automatically granted. In other cases when proxy access is requested, the request may be presented to a patient the next time the patient logs onto the system and the patient may have to affirmatively grant access to the proxy. To this end, see FIG. 25 which includes a window view 330 that may be provided by server 12 when a potential proxy accesses a facility web portal via interface device 22. View 330 includes instructions 332, a field 334 for entering a patient's name, a field for entering a potential proxies name 336 and an ENTER icon 338. Instructions 332 instruct the potential proxy to fill in fields 334 and 336 and to select ENTER icon to submit the information.

Referring also to FIG. 26, an exemplary method 340 for processing a potential proxy request is illustrated. At block 342 an ADPI access request is received by server 12. At block 344 server 12 presents the request to the corresponding patient. At block 346, if the patient rejects the request, the process ends. In the alternative, when a request is rejected, in at least some cases, a notice of rejection is transmitted to the requesting party. If the patient accepts the request at block 346, control passes to block 348 where server 12 generates information related to the requesting proxy for storage in the proxy access database (see again FIG. 11) and may generate a return e-mail to the requesting party indicating that access was authorized and, in at least some cases, providing username and password information to facilitate access.

Moreover, in the above description and the claims that follow, it should be appreciated that the term “physician” is used in a broad sense to cover anyone associated with a medical facility including but not limited to doctors, nurses, orderlies, nurses aides, administrative staff, etc.

Furthermore, in at least some embodiments where MyChart or a similar software reporting/interacting tool exists, it is contemplated that proxies and/or observers may be specified prior to an admit period by a patient using a MyChart portal. Similarly, healthcare agents and powers of attorney may be specified using MyChart or a similar product. Here, proxy access may automatically be given to anyone that has proxy access authority prior to an admit period.

Moreover, where MyChart accounts exist prior to an admit period, a patient's MyChart account may be directly linked to an inpatient account as described above or the two accounts and related information could be combined where a proxy has a MyChart account, a proxy access link may be provided to enable the proxy to access the patient's inpatient information or even to access the patient's MyChart account. In the alternative, inpatient information/control tools may be provided to the proxy as an integral part of the proxy's MyChart account.

In addition, in a fashion similar to that described above where a person requests proxy access, patients and/or potential proxies and/or potential observers may be provided with screen shots that allow each to request information and/or functional capabilities that they do not already have. Here, patient requests would be to physicians or facility administrators while proxy requests could be to patients, physicians and/or administrators.

Moreover, in at least some embodiments at least some information may be deemed to an sensitive to be released or only releasable after agreement from a second entity. For instance, mental health information (e.g., depression, etc.) may not be releasable to a proxy unless both a patient and an attending physician agree. Here, if a patient authorizes release to a proxy, a message may automatically be sent to a physician to obtain authorization to release. Where the physician denies release, release would be barred. In these cases it is contemplated that at least some information may be flagged or marked as sensitive and release rules would be specified accordingly.

Thus, the invention is to cover all modifications, equivalents, and alternatives falling within the spirit and scope of the invention as defined by the following appended claims.

To apprise the public of the scope of this invention, the following claims are made:

What is claimed is:

1. A method for making information associated with a patient at a medical facility available, the method comprising the steps of:
providing a processor, a database and at least a first interface device, the processor linked to each of the interface device and the database via a network; and
during an admit period that occurs between admission of a first patient to and discharge of the first patient from the facility, allowing at least one of the first patient and a proxy for the first patient to access at least a subset of admit period information associated with the first patient that reflects activities related to the first patient that occur during the admit period where the admit period information includes official facility generated information.

2. The method of claim 1 further including the steps of, during the admit period, assigning a unique medical information account in the database to the first patient where the assigned account is a first patient's account and posting the subset of the admit period information on the first patient's account, the step of allowing access including allowing access to the first patient's account via the interface.

3. The method of claim 1 wherein the step of allowing access includes providing access information to at least one of the first patient and the proxy for the first patient and requiring entry of the access information via the at least a first interface device prior to accessing the subset of admit period information associated with the first patient.

4. The method of claim 3 wherein the step of providing access information includes providing access information to the first patient when admitted.

5. The method of claim 3 wherein the step of providing the access information includes allowing the patient to provide the access information to the proxy to facilitate proxy access to the subset of admit period information.

6. The method of claim 3 wherein the step of providing access information further includes providing first and second different subsets of access information to the first patient and the proxy, respectively, wherein the first and second different access information subsets enable access to different subsets of the admit period information associated with the first patient.

7. The method of claim 1 wherein the subset of admit period information associated with the first patient includes at least a subset of test results, condition during admit period, patient schedule, medicant consumption, surgical outcomes, progress notes, vital statistics, flow sheet documentation, physician interaction, patient posted information, physician posted information, proxy posted information, insurance information, medical images, administrative procedural documents, medical procedural documents, food menu options, current diagnosis, past diagnosis, level of consciousness, patient characteristics, visitation schedule and patient diet.

8. The method of claim 1 wherein the step of allowing access includes allowing access by the proxy, the method further including the step of allowing the first patient to select the information subset accessible by the proxy.

9. The method of claim 8 wherein the step of allowing the first patient to select the information subset accessible by the proxy includes providing pre-configured options for the first patient to select from.

10. The method of claim 8 wherein the step of allowing the first patient to select the information subset accessible by the proxy includes allowing the first patient to select specific information that the proxy is unable to access.

11. The method of claim 1 wherein the step of allowing access includes obtaining a network address associated with the proxy, assigning access information to the proxy and transmitting the access information to the proxy via the network.

12. The method of claim 1 further including the steps of monitoring and archiving access by at least one of the proxy and the first patient to the subset of admit period information associated with the first patient.

13. The method of claim 1 wherein the step of allowing access includes allowing each of the patient and the proxy to access at least a subset of the admit period information associated with the first patient.

14. The method of claim 1 wherein the step of allowing access includes allowing at least first and second different proxies to access at least subsets of the admit period information associated with the first patient.

15. The method of claim 14 wherein the step of allowing at least first and second different proxies to access includes allowing the at least first and second different proxies to access different subsets of the admit period information associated with the-first patient.

16. The method of claim 1 wherein the step of allowing access includes allowing the proxy to access the subset of admit period information associated with the first client, the method further including allowing the proxy to provide information via the interface, associating the proxy provided information with the admit period information associated with the first patient and storing the admit period and associated information in the database.

17. The method of claim 2 wherein medical records generated within the facility are used to update the first patient's account information essentially in real time.

18. The method of claim 1 wherein the step of providing at least a first interface device includes providing an interface remote from the facility for use by a proxy for the first patient.

19. The method of claim 1 wherein the step of providing at least a first interface device includes, during the admit period, providing an inpatient interface device.

20. The method of claim 1 further including, prior to the step of allowing access, obtaining legal consent from at least one of the patient and a legal representative of the patient for the proxy to access.

21. The method of claim 1 wherein the step of allowing access includes enabling the at least one of the patient to post information to be accessed subsequently by at least one of a physician and a proxy and enabling the proxy to post information to be accessed subsequently by at least one of a physician, a second proxy and the patient.

22. The method of claim 1 further including the step of enabling a physician to post information to be accessed subsequently by at least one of the patient and the proxy.

23. The method of claim 1 further including the step of allowing at least one of the first patient and a proxy for the first patient to enter information via the interface device that is associated with the first patient.

24. The method of claim 23 wherein the step of allowing entry of information includes receiving the entered information and performing a process associated with the entered information wherein the process is at least one of scheduling an appointment, storing perceived patient condition information, storing information related to a specific record, distributing information to at least one of the patient, at least a second proxy, an observer, a physician and another entity, filling in an administrative procedural document, filling in a medical procedural document, selecting a menu option and amending a visitation schedule.

25. The method of claim 1 further including the step of enabling at least one of the first patient and a proxy for the first patient to at least one of grant access to at least a subset of admit period information associated with the first patient to another party and modify access of another party to access the subset of admit period information.

26. The method of claim 25 further including the step of enabling at least one of the first patient and a proxy for the first patient to at least one of grant and modify functional capabilities of another party that are associated with the first patient.

27. The method of claim 25 wherein the another party is one of a proxy and an observer.

28. A method for making information associated with a patient at a medical facility available, the method comprising the steps of:
providing a processor, a database and interfaces, the processor linked to each of the interfaces and the database via a network; and
during an admit period that occurs between admission of a first patient to and discharge of the first patient from the facility, allowing each of at least first and second different proxies for the first patient to access at least a subset of admit period information associated with the first patient that reflects activities related to the first patient that occur during the admit period where the admit period information includes official facility generated information.

29. The method of claim 28 further including the steps of, during the admit period, assigning a unique medical information account in the database to the first patient where the assigned account is a first patient's account and posting the subset of the admit period information on the first patient's account, the step of allowing access including allowing access to the first patient's account via the interface.

30. The method of claim 29 wherein the step of allowing access includes providing access information to at least one of the first patient and the proxy for the first patient and requiring entry of the access information via the at least a first interface device prior to accessing the subset of admit period information associated with the first patient.

31. The method of claim 29 wherein the step of providing access information includes providing different first and second access information to each of the at least first and second proxies, respectively.

32. The method of claim 31 wherein the information subsets accessible via entry of the first and second access information includes first and second different subsets, respectively.

33. The method of claim 30 wherein the step of providing interfaces includes at least providing an interface remote from the facility for use by a proxy for the first patient.

34. The method of claim 30 wherein the step of providing interfaces includes, during the admit period, at least providing an inpatient interface device for use by the first patient.

35. The method of claim 28 further including the step of allowing at least one of the proxies for the first patient to enter information via the interface device that is associated with the first patient.

36. The method of claim 35 wherein the step of allowing entry of information includes receiving the entered information and performing a process associated with the entered information wherein the process is at least one of scheduling an appointment, storing perceived patient condition information, storing information related to a specific record, distributing information to at least one of the patient, at least a second proxy, an observer, a physician and another entity, filling in an administrative procedural document, filling in a medical procedural document, selecting a menu option and amending a visitation schedule.

37. The method of claim 28 further including the step of enabling at least one of the proxies to at least one of grant access to at least a subset of admit period information associated with the first patient to another party and modify access of another party to access the subset of admit period information.

38. The method of claim 37 further including the step of enabling at least one of the proxies to at least one of grant and modify functional capabilities of another party that are associated with the first patient.

39. A method for making information associated with a patient at a medical facility available, the method comprising the steps of:
providing a processor, a database and at least a first interface device, the processor linked to each of the interface device and the database via a network;
during an admit period that occurs between admission to and discharge from the facility of a first patient:
receiving identification from the first patient identifying at least one proxy for the first patient that is to be authorized to access at least a subset of admit period information that reflects activities related to the first patient that occur during the admit period where the admit period information includes official facility generated information; and
via the interface, allowing the at least one proxy to access at least a subset of the admit period information associated with the first patient.

40. The method of claim 39 further including the steps of assigning a unique medical information account in the database to the first patient and posting the admit period information associated with the first patient on the first patient's account and, after receiving identification, assigning access information to the at least one proxy for accessing the subset of admit period information, the step of allowing access including providing the admit period information associated with the first patient when the proxy enters the access information via the interface device.

41. The method of claim 39 wherein the step of providing at least a first interface device includes providing an interface remote from the facility for use by a proxy for the first patient.

42. The method of claim 39 wherein the step of providing at least a first interface device includes, during the admit period, providing an inpatient interface device for use by the first patient.

43. A method for making information associated with a patient at a medical facility available, the method comprising the steps of:
providing a processor, a database and at least first and second interfaces, the processor linked to each of the interfaces and the database via a network;
during an admit period that occurs between admission to and discharge from the facility of a first patient:
via the first interface:
allowing the first patient to access at least a first subset of admit period information associated with the first patient where the admit period information includes official facility generated information that reflects activities related to the first patient that occur during the admit period;
enabling the first patient to select a second subset from the first subset to be made available to at least a first proxy for the first patient; and
via the second interface:
allowing the at least a first proxy to access the at least a second subset of the information selected by the first patient.

44. The method of claim 43 further including the step of, during the admit period, assigning a unique medical information account in the database to the first patient, the step of allowing the first patient to access including posting the admit period information on the first patient's account and allowing the first patient to access the first patient's account.

45. The method of claim 43 further including the step of, via the first interface, enabling the first patient to identify the at least a first proxy.

46. The method of claim 43 further including the step of enabling the first patient to identify a plurality of proxies for the first patient wherein the step of allowing the at least a first proxy includes allowing each of the plurality of proxies to access at least a subset of the first subset of information.

47. The method of claim 43 wherein the step of enabling the first patient to select includes enabling the first patient to select multiple different subsets of the first information subset, the method further including the step of enabling the first patient to identify a plurality of different proxies via the first interface and associating each of the proxies with a different one of the multiple different subsets, the step of allowing the at least a first proxy to access including allowing each of the proxies to access the associated one of the multiple different subsets.

48. The method of claim 43 wherein the step of providing a second interface device includes providing an interface remote from the facility for use by a proxy for the first patient.

49. The method of claim 43 wherein the step of providing a first interface device includes, during the admit period, providing an inpatient interface device for use by the first patient.

50. A method for making information associated with a patient at a medical facility available, the method comprising the steps of:
providing a processor, a database and at least a first interface, the processor linked to each of the interface and the database via a network;
during an admit period that occurs between admission of a first patient to and discharge of the first patient from the facility:
via one of the at least a first interface:
allowing at least one of a first patient, a first proxy for the first patient and a physician to access at least a subset of medical information associated with the first patient including at least some admit period information that reflects activities related to the first patient that occur at the facility during the admit period;
enabling the at least one of the first patient, the first proxy and the physician to identify at least a subset of the accessed information associated with the first patient to be posted for a second proxy to access; and
rendering the subset of accessed information identified by the at least one of the first patient, the proxy and the physician accessible to the second proxy via one of the at least a first interface.

51. The method of claim 50 further including the steps of:
via one of the at least a first interface:
enabling at least one of a first patient, a proxy for the first patient and a physician to specify functional capabilities associated with the first patient that can be performed by another proxy; and
facilitating the functional capabilities identified by the at least one of the first patient, the proxy and the physician accessible to the another proxy via one of the at least a first interface.

52. A system for making information associated with a patient at a medical facility available, the system comprising:
a database;
at least a first interface device; and
a processor linked to each of the interface device and the database via a network, wherein, the processor is programmed to perform the method of, during an admit period that occurs between admission of a first patient to and discharge of the first patient from the facility, allowing at least one of the first patient and a proxy for the first patient to access at least a subset of admit period information associated with the first patient that reflects activities related to the first patient that occur during the admit period where the admit period information includes official facility generated information.

53. The system of claim 52 wherein the subset of admit period information associated with the first patient includes at least a subset of test results, condition during admit period, patient schedule, medicant consumption, surgical outcomes, progress notes, vital statistics, flow sheet documentation, physician interaction, patient posted information, physician posted information, proxy posted information, insurance information, medical images, administrative procedural documents, medical procedural documents, food menu options, current diagnosis, past diagnosis, level of consciousness, patient characteristics, visitation schedule and patient diet.

54. The system of claim 52 wherein the step of allowing access includes allowing access by the proxy, processor further programmed to perform the step of allowing the first patient to select the information subset accessible by the proxy.

55. The system of claim 52 wherein the step of allowing access includes obtaining a network address associated with the proxy, assigning access information to the proxy and transmitting the access information to the proxy via the network.

56. The system of claim 52 wherein the at least a first interface device includes an interface remote from the facility for use by a proxy for the first patient.

57. The system of claim 52 wherein the at least a first interface device is an inpatient interface device for use by the first patient.

58. A system for making information associated with a patient at a medical facility available, the system comprising:
a database;
at least a first interface device; and
a processor linked to each of the interface device and the database via a network, wherein, the processor is programmed to perform the method of, during an admit period that occurs between admission of a first patient to and discharge of the first patient from the facility, allowing each of at least first and second different proxies for the first patient to access at least a subset of admit period information associated with the first patient that reflects activities related to the first patient that occur during the admit period where the admit period information includes official facility generated information.

59. A system for making information associated with a patient at a medical facility available, the system comprising:
a database;
at least a first interface device; and
a processor linked to each of the interface device and the database via a network, wherein, the processor is programmed to perform the method of, during an admit period that occurs between admission to and discharge from the facility of a first patient, receiving identification from at least one of the first patient, a proxy for the first patient and a physician identifying at least another proxy for the first patient that is to be authorized to access at least a subset of admit period information that reflects activities related to the first patient that occur during the admit period where the admit period information includes official facility generated information, receiving identification from the at least one of the first patient, the proxy for the first patient and the physician identifying at least another proxy for the first patient that is to be authorized to access at least a subset of the admit period information associated with the first patient and, via the interface, allowing the at least another proxy to access at least a subset of the admit period information associated with the first patient.

60. A method for making information associated with a patient at a medical facility available, the method comprising the steps of:
a database;
at least a first interface device; and
a processor linked to each of the interface device and the database via a network, wherein, the processor is programmed to perform the method of, during an admit period that occurs between admission of a first patient to and discharge of the first patient from the facility:
allowing the first patient to access at least a subset of medical information associated with the first patient including at least some admit period information that reflects activities related to the first patient that occur at the facility during the admit period;
enabling the first patient to identify at least a subset of the accessed information associated with the first patient to be posted for a proxy to access; and
rendering the subset of accessed information identified by the first patient accessible to the proxy via one of the at least a first interface.

61. A method for making information associated with a patient at a medical facility available wherein a first proxy is already authorized to access at least a first subset of information associated with the first patient that reflects activities related to the first patient that occur during an admit period that occurs between admission of the first patient to and discharge of the first patient from the facility where the admit period information includes at least official facility generated information, the method comprising the steps of:
providing a processor, a database and at least a first interface device, the processor linked to each of the interface device and the database via a network; and
during the admit period:
allowing the first proxy to identify at least a second proxy to have access to at least a portion of the first subset of information;
storing an indication that the second proxy has authority to access the at least a portion of the first subset; and
allowing the second proxy to access the at least a portion of the first subset.

62. The method of claim 61 further including the step of allowing the first proxy to identify the portion of the first subset to which the second proxy has access.

63. A method for making information associated with a first patient at a medical facility available via an interface wherein a first party is already authorized to access a first subset of posted information associated with the first patient that reflects activities related to the first patient that occur during an admit period that occurs between admission of the first patient to and discharge of the first patient from the facility where the admit period information includes at least official facility generated information, the method comprising the steps of:
providing a processor, a database and a plurality of interfaces, the processor linked to each of the interfaces and the database via a network; and
during the admit period:
receiving via one of the interfaces and from an authorizing party, an indication that a second subset of information that the first party is not initially authorized to access and that is associated with the first patient that reflects activities related to the first patient that occur during an admit period is to be accessible to the first party; and
posting the second subset of information for access by the first party via one of the interfaces.

64. The method of claim 63 wherein the first party is one of the first patient, a proxy for the first patient and a physician.

65. The method of claim 63 wherein the authorizing party is one of the first patient, a proxy for the first patient and a physician.

66. The method of claim 63 further including the step of enabling the authorizing party to attach a comment to the second subset.

67. The method of claim 66 wherein, after the comment is attached to the second subset, when the first party accesses the second subset, the comment is included with the second subset.
